(19) United States
(12) Patent Application Publication
(10) Pub. No.: US 2009/0310978 A1
(43) Pub. Date: Dec. 17, 2009

(54) COMPLEMENTARY OPTICAL WIRING SYSTEM

(75) Inventors: Hiroshi Uemura, Yokohama-shi (JP); Hideto Furuyama, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/470,737

(22) Filed: May 22, 2009

(30) Foreign Application Priority Data
Jun. 11, 2008 (JP) 2008-152513

(51) Int. Cl. H04B 10/04; H04B 10/00; H04B 10/12

(52) U.S. Cl. 398/195; 327/155; 398/154; 375/360; 398/189

(57) ABSTRACT

A complementary optical wiring system has a transmitting circuit configured to combine a delayed signal obtained by delaying a digital electric input signal by a time shorter than a minimum pulse width of the digital electric input signal with the digital electric input signal to generate a first electric pulse signal synchronized with a rising edge of the digital electric input signal and a second electric pulse signal synchronized with a falling edge of the digital electric input signal, a first light-emitting element configured to convert the first electric pulse signal to a first optical signal, a second light-emitting element configured to convert the second electric pulse signal to a second optical signal, a first optical transmission path configured to transmit the first optical signal, a second optical transmission path configured to transmit the second optical signal, a first light-receiving element configured to convert the first optical signal transmitted through the first optical transmission path to a third electric pulse signal, a second light-receiving element configured to convert the second optical signal transmitted through the second optical transmission path to a fourth electric pulse signal and a receiving circuit configured to generate a digital electric output signal corresponding to the digital electric input signal in synchronization with the third and fourth electric pulse signals.

### CROSS REFERENCE TO RELATED APPLICATIONS

This application is based upon and claims the benefit of priority from the prior Japanese Patent Applications No. 2008-152513, filed on Jun. 11, 2008, the entire contents of which are incorporated herein by reference.

### BACKGROUND

In recent years, a problem such as delays, loss, noise or the like is emphasized in signal transmission between LSI chips. In personal computers and mobile communication devices such as mobile phones in particular, noise interference between various radio signals and electric signals in the devices are becoming controversial. EMI (Electromagnetic Interference) that affects other electronic devices or circuits through emission of electromagnetic noise and EMS (Electromagnetic Susceptibility) that receives influences of electromagnetic noise from other electronic devices or circuits are becoming controversial. Therefore, a concept of EMC (Electromagnetic Compatibility) satisfying both EMI and EMS is becoming more and more important in the field of device design.

Under such circumferences, there is an increasing trend to apply optical signals which are not only high speed and low loss but also free of electromagnetic noise to signal transmission between LSI chips. However, since a finite power supply such as a battery is used in a mobile device, electronic parts in the device are strongly required to achieve low power consumption. The same applies even when light is used as a signal transmitter. A complementary optical wiring scheme JP-A No. 3-58532 (Kokai) (hereinafter, “Patent Document 1”), JP-A No. 2001-285195 (Kokai) (hereinafter, “Patent Document 2”)), optical wiring scheme JP-A No. 7-38504 (Kokai) (hereinafter, “Patent Document 3”), JP-A No. 54-152901 (Kokai) (hereinafter, “Patent Document 4”), JP-A No. 60-74825 (Kokai) (hereinafter, “Patent Document 5”) and U.S. Pat. No. 4,397,042 (hereinafter, “Patent Document 6”)) have been proposed so far.

### SUMMARY

According to one aspect of the present invention, a complementary optical wiring system comprising: a transmitting circuit configured to combine a delayed signal obtained by delaying a digital electric input signal by a time shorter than a minimum pulse width of the digital electric input signal with the digital electric input signal to generate a first electric pulse signal synchronized with a rising edge of the digital electric input signal and a second electric pulse signal synchronized with a falling edge of the digital electric input signal; a first light-emitting element configured to convert the first electric pulse signal to a first optical signal; a second light-emitting element configured to convert the second electric pulse signal to a second optical signal; a first optical transmission path configured to transmit the first optical signal; a second optical transmission path configured to transmit the second optical signal; a first light-receiving element configured to convert the first optical signal transmitted through the first optical transmission path to a third electric pulse signal; a second light-receiving element configured to convert the second optical signal transmitted through the second optical transmission path to a fourth electric pulse signal; and a receiving circuit configured to generate a digital electric output signal corresponding to the digital electric input signal in synchronization with the third and fourth electric pulse signals.

According to the other aspect of the present invention, a complementary optical wiring system comprising: a transmitting circuit comprising a first frequency division circuit configured to generate a first frequency-divided signal whose logic is inverted in synchronization with a rising edge of a digital electric input signal, a second frequency division circuit configured to generate a second frequency-divided signal whose logic is inverted in synchronization with a falling edge of the digital electric input signal, a first electric pulse signal generation circuit configured to generate a first electric pulse signal at timing synchronized with a logical transition of the first frequency-divided signal and a second electric pulse signal generation circuit configured to generate a second electric pulse signal at timing synchronized with a logical transition of the second frequency-divided signal; a first light-emitting element configured to generate a first optical signal synchronized with the first electric pulse signal; a second light-emitting element configured to generate a second optical signal synchronized with the second electric pulse signal; a first optical transmission path configured to transmit the first optical signal; a second optical transmission path configured to transmit the second optical signal; a first light-receiving element configured to convert the first optical signal transmitted through the first optical transmission path to a third electric pulse signal; a second light-receiving element configured to convert the second optical signal transmitted through the second optical transmission path to a fourth electric pulse signal; and a receiving circuit configured to generate a digital electric output signal corresponding to the digital electric input signal in synchronization with the third and fourth electric pulse signals.

According to the other aspect of the present invention, a complementary optical wiring system comprising: a transmitting circuit configured to generate first and second electric pulse signals synchronized with a rising edge and a falling edge of a digital electric input signal; a first light-emitting element configured to generate a first optical signal synchronized with the first electric pulse signal; a second light-emitting element configured to generate a second optical signal synchronized with the second electric pulse signal; a first optical transmission path configured to transmit the first optical signal; a second optical transmission path configured to transmit the second optical signal; a first light-receiving element configured to convert the first optical signal transmitted through the first optical transmission path to a third electric pulse signal; a second light-receiving element configured to convert the second optical signal transmitted through the second optical transmission path to a fourth electric pulse signal; a receiving circuit comprising a digital received signal generation circuit configured to generate a digital electric output signal corresponding to the digital electric input signal in synchronization with the third and fourth electric pulse signals and a feedback signal generation circuit configured to generate a feedback signal indicating whether a peak voltage of the digital electric output signal exceeds a first reference voltage or whether a voltage-amplitude of the digital electric output signal exceeds a second reference voltage, or whether a voltage proportional to the amount of the jitter of the digital electric output signal exceeds a third reference voltage; and a feedback signal transmission path configured to be connected to the transmitting circuit and the receiving circuit and configured to transmit the feedback signal from the receiving circuit to the transmitting circuit, wherein the transmitting circuit comprises a control circuit configured to control an amount of optical output of the first and second optical signals based on the feedback signal.

### BRIEF DESCRIPTION OF THE DRAWINGS

FIG. 1 is a block diagram showing a schematic configuration of a complementary optical wiring system according to a first embodiment of the present invention;

FIG. 2 is timing charts of nodes A to D in the system in FIG. 1;

FIG. 3 is a circuit diagram showing a schematic configuration of a complementary optical wiring system according to a second embodiment of the present invention;

FIG. 4 is timing charts of the respective parts in FIG. 3;

FIG. 5 is a circuit diagram showing an example of the internal configuration of the first and second delay circuits;

FIG. 6 is a circuit diagram showing a schematic configuration of the complementary optical wiring system showing a modification example of FIG. 3;

FIG. 7 is timing charts of the respective parts in FIG. 6;

FIG. 8 is a modification example of FIG. 3 and is a circuit diagram showing a schematic configuration when a trans-impedance configuration is adopted for the receiving circuit 10;

FIG. 9 is a perspective view showing an example of a complementary optical wiring module mounted with the system in FIG. 3 or FIG. 6;

FIG. 10 is a circuit diagram showing a schematic configuration of a complementary optical wiring system according to a third embodiment of the present invention;

FIG. 11 is timing charts of nodes A to H in the system of FIG. 10;

FIG. 12 is a circuit diagram showing a modification example of FIG. 10;

FIG. 13 is a circuit diagram showing a schematic configuration of a complementary optical wiring system according to a fourth embodiment of the present invention;

FIG. 14 is a circuit diagram showing a modification example of FIG. 13;

FIG. 15(a) is a circuit diagram of a variable resistance element composed of three MOS transistors Q7 to Q9;

FIG. 15(b) is a circuit diagram of a variable resistance element composed of only one MOS transistor Q10;

FIG. 16 is a circuit diagram showing a modification example of FIG. 10;

FIG. 17(a) is a circuit diagram showing a first example of the internal configuration of variable delay circuit 61 in FIG. 16;

FIG. 17(b) is a circuit diagram showing a second example of the internal configuration of the variable delay circuit 61 in FIG. 16;

FIG. 18 is a circuit diagram showing a modification example of the internal configuration of the transmitting circuit 2 shown in FIG. 10, FIG. 12, FIG. 13, FIG. 14 or FIG. 16;

FIG. 19 is timing charts of nodes A to H in FIG. 18;

FIG. 20 is a circuit diagram showing a schematic configuration of a complementary optical wiring system showing an example where a differential digital electric input signal is inputted to the transmitting circuit 2;

FIG. 21 is timing charts of nodes A to H in FIG. 20;

FIG. 22 is a block diagram showing a schematic configuration of a complementary optical wiring system according to a fifth embodiment of the present invention;

FIG. 23 is timing charts of nodes A to E in FIG. 22;

FIG. 24 is a circuit diagram showing a schematic configuration of a complementary optical wiring system according to a sixth embodiment of the present invention;

FIG. 25 is timing charts of nodes A to H in FIG. 24;

FIG. 26 is a circuit diagram showing a modification example of FIG. 24;

FIG. 27 is a circuit diagram showing a modification example where a separation circuit 72 having a circuit configuration different from that in FIG. 24;

FIG. 28 is timing charts of nodes A to I in FIG. 27;

FIG. 29 is a block diagram showing a schematic configuration of a complementary optical wiring system according to a seventh embodiment of the present invention; FIG. 30 is timing charts of nodes A to C in FIG. 29;

FIG. 31 is a circuit diagram of a complementary optical wiring system according to an eighth embodiment of the present invention;

FIG. 32 is timing charts of nodes A to E in FIG. 31;

FIG. 33 is a circuit diagram showing a schematic configuration of a complementary optical wiring system according to a ninth embodiment of the present invention;

FIG. 34 is timing charts of nodes A to H in FIG. 33;

FIG. 35 is a circuit diagram showing a modification example of FIG. 33;

FIG. 36 is timing charts of nodes A to H in FIG. 35;

FIG. 37 is a circuit diagram with bias current supply resistance elements 105 to 108 added to the circuit in FIG. 33;

FIG. 38 is timing charts of nodes A to H in FIG. 37;

FIG. 39 is a circuit diagram of a complementary optical wiring system according to a tenth embodiment of the present invention;

FIG. 40 is timing charts of nodes A to F in FIG. 39;

FIG. 41 is a circuit diagram showing a modification example with bias current supply resistance elements added to the circuit in FIG. 39;

FIG. 42 is a circuit diagram showing an example of internal configuration of variable capacitors 120 and 121 in FIG. 41;

FIG. 43 is block diagram showing a schematic configuration of a complementary optical wiring system according to an eleventh embodiment of the present invention;

FIG. 44 is a block diagram showing a modification example with a control circuit 132, feedback path 131 and feedback signal generation circuit 134 added to the circuit in FIG. 39;

FIG. 45 is a circuit diagram showing a first modification example of the circuit in FIG. 10;

FIG. 46 is a circuit diagram showing a second modification example of the circuit in FIG. 10; and

FIG. 47 is a circuit diagram showing a third modification example where the receiving circuit 10 in FIG. 46 has been improved.

### DETAILED DESCRIPTION OF THE INVENTION

First, technical differences between the above described Patent Documents 1 to 6 and embodiments of the present invention will be explained briefly.

Patent Documents 1 and 2 disclose the techniques intended to reduce optical power by alternately turning on two diode type light-emitting elements through a CR differential current that flows during transition of a digital electric input signal and transmitting signals of only rising information and falling information of the digital electric input signal. However, the techniques disclosed in Patent Document 1 and 2 may involve various problems that deteriorate signal transmission characteristics such as waveform distortion due to a pattern effect, shortage of light-emitting current due to time constant restrictions and further the occurrence of excessive pulses due to an inrush current during burst operation.

Explaining more specifically, since the attenuation time of a CR differential current is proportional to a CR time constant, the CR time constant determined by the product of a total C of respective capacitances of capacitors and light-emitting elements and resistances R of the respective light-emitting elements must be sufficiently small compared to the minimum pulse width of the digital electric input signal. When the CR time constant is not sufficiently small, if the CR differential current pulses are produced consecutively at short time intervals, these pulses overlap with each other, thereby changing the subsequent CR differential current waveforms. That is, a so-called “pattern effect” is produced, in which the waveform of a CR differential current varies depending on the waveform (pulse interval) of an electric input pulse.

Furthermore, for a high-speed electric input pulse exceeding 1 Gbps (minimum bit width is smaller than 1 ns), for example, the capacitances of the capacitors need to be extremely small to sufficiently reduce the CR time constant, but it is difficult to produce a sufficient amount of light-emitting current necessary for light emission of the light-emitting element.

Furthermore, due to an ON-voltage characteristic (rising voltage VF) specific to the diode type light-emitting element, a large inrush current for charging the VF component flows and excessive pulses are likely to be generated during a burst operation from a state in which the capacitors are completely discharged (capacitor voltage: approximately 0 V) to an operating state (capacitor voltage: approximately VF).

As described above, Patent Documents 1 and 2 may involve various problems that lead to deterioration of signal transmission characteristics, and the embodiments of the present invention is intended to solve such problems by generating pulse signals without performing differential processing as will be described later.

Patent Document 3 discloses an optical wiring circuit whereby a clock signal and a data signal are pulsed and optical transmission is carried out. Pulsing can reduce power consumption more than general optical wiring that optically transmits a digital electric input signal itself. However, since data signals are pulsed in clock cycles using a pulsed clock signal, an optical signal is generated for every bit even when a data signal with consecutive bits such as “1111 . . . ” is transmitted. Therefore, compared to the case of the embodiments of the present invention where only rising information and falling information of the digital electric input signal are optically transmitted, the effect of reduction of power consumption is significantly small. That is, while optical power can be reduced in the digital electric input signal based on an NRZ scheme with a low signal transition probability (frequency of rising and falling) in the complementary optical wiring system according to the embodiments of the present invention, the optical wiring circuit according to Patent Document 3 cannot benefit from the effect at all.

Furthermore, in the case of Patent Document 3, a data signal generated on the receiving side is always based on an RZ scheme, and therefore data signal transmission based on an NRZ scheme requires the receiving side to have a separate conversion circuit to convert from the RZ scheme to the NRZ scheme, which may increase the device cost.

Since the technique according to Patent Document 3 does not use CR differential current, it is possible to avoid problems with the pattern effect, shortage of light-emitting current and excessive pulses described in Patent Documents 1 and 2. However, since a data signal is pulsed using a pulsed clock signal, a clock signal input is indispensable for the transmitting side circuit. Furthermore, since a clock signal is also used to reproduce a data signal on the receiving side, not only a data signal but also the clock signal needs to be optically transmitted. Therefore, not only the transmitting circuit and receiving circuit become more complicated, but also a transmission medium for an optical signal requires a clock signal line and it is difficult to reduce the size of the transmission medium. Furthermore, power consumption increases due to clock signal transmission of high transition probability. On the other hand, according to the below described embodiments of the present invention, it is possible to perform pulsing by using only a digital electric input signal as will be described later, and the present embodiments does not always require input or transmission of another signal such as a clock signal.

Patent Document 4 discloses a technique of pulsing a clock signal and a data signal using separate gate signals having the same cycle as that of the clock signal, converting the signals to optical signals and transmitting the optical signals. Since the technique according to Patent Document 4 requires a new gate signal to be generated, the circuit becomes more complicated. Furthermore, as in the case of Patent Document 3, since an optical pulse is generated for every bit in transmission of consecutive bits of a digital electric input signal, the effect of reduction of power consumption is significantly small. Since a data signal generated on the receiving side is always based on the RZ scheme, the receiving side needs to be provided with a separate conversion circuit to convert from the RZ scheme to the NRZ scheme for signal transmission based on the NRZ scheme. Furthermore, not only the data signal but also a clock signal needs to be optically transmitted, which increases the size of a transmission medium and significantly reduces the effect of low power consumption.

Patent Document 5 discloses a technique of performing differential processing on a digital electric input signal, generating pulse signals at a rising edge and a falling edge of the digital electric input signal and converting the generated pulse signal to an optical signal. Unlike the embodiments of the present invention, the technique according to Patent Document 5 transmits both an optical pulse corresponding to the rising edge and an optical signal corresponding to the falling edge through the same optical transmission path. Therefore, the receiving side circuit cannot distinguish whether a transmitted optical signal corresponds to the rising edge or the falling edge of the digital electric input signal. The receiving side circuit simply performs rising and falling of the digital electric output signal in sequence every time the optical signal arrives. As a result, when, for example, the receiving side fails to receive even one optical signal due to the influence of noise, it is impossible to further generate digital electric output signals correctly. Furthermore, when the pulse width of a digital electric input signal is small, an optical signal corresponding to the rising edge and an optical signal corresponding to the falling edge interfere with each other, which may cause a problem with optical transmission and optical signal reception.

Patent Document 6 discloses an optical wiring circuit that pulses “1” (high) and “0” (low) of a digital electric input signal so as to have a polarity opposite to a certain potential and performs optical transmission. Pulsing may result in less power consumption than general optical wiring that optically transmits the digital electric input signal itself. However, during a non-pulse transmission time such as a time between contiguous pulses, the technique according to Patent Document 6 generates an optical signal having intermediate intensity between a pulse with positive polarity and pulse with negative polarity. Therefore, the effect of reduction in power consumption is significantly small compared to optical signal transmission of only pulses as in the case of the embodiments of the present invention.

The below described present embodiments provides a complementary optical wiring system that can make reduction of power consumption compatible with quality improvement of signal transmission characteristics. Hereinafter, the present embodiments will be explained with reference to accompanying drawings.

### First Embodiment

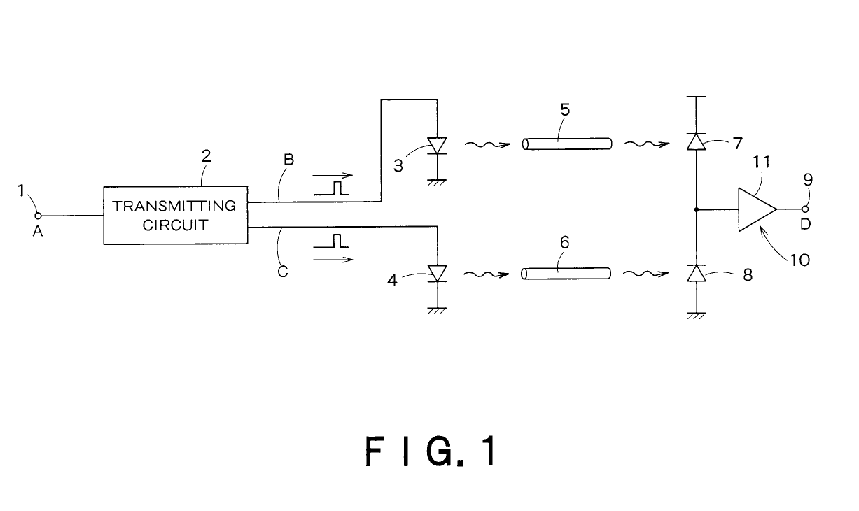

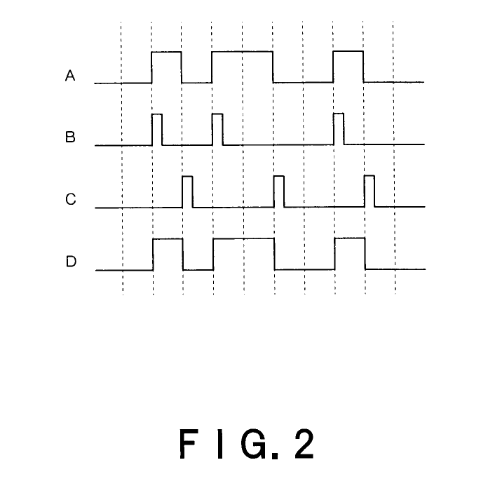

FIG. 1 is a block diagram showing a schematic configuration of a complementary optical wiring system according to a first embodiment of the present invention and FIG. 2 is timing charts of nodes A to D in the system in FIG. 1. The system in FIG. 1 has a transmitting circuit 2, a first light-emitting element 3, a second light-emitting element 4, a first optical transmission path 5, a second optical transmission path 6, a first light-receiving element 7, a second light-receiving element 8 and a receiving circuit 10.

The transmitting circuit 2 combines a delayed signal resulting from delaying a digital electric input signal inputted from an input terminal 1 by a time shorter than a minimum pulse width of the digital electric input signal with the digital electric input signal, and thereby generates a first electric pulse signal that is synchronized with a rising edge of the digital electric input signal and has a pulse width corresponding to the delay time, and a second electric pulse signal that is synchronized with a falling edge of the digital electric input signal and has a pulse width corresponding to the delay time. The first light-emitting element 3 converts the first electric pulse signal to a first optical signal. The second light-emitting element 4 converts the second electric pulse signal to a second optical signal. The first optical transmission path 5 transmits the first optical signal. The second optical transmission path 6 transmits the second optical signal. The first light-receiving element 7 converts the first optical signal transmitted through the first optical transmission path 5 to a third electric pulse signal. The second light-receiving element 8 converts the second optical signal transmitted through the second optical transmission path 6 to a fourth electric pulse signal. The receiving circuit 10 generates a digital electric output signal corresponding to the digital electric input signal in synchronization with the third and fourth electric pulse signals and outputs the digital electric output signal from an output terminal 9.

As will be described in detail in the following embodiments, the transmitting circuit 2 generates the first and second electric pulse signals using logic circuits and transistors without performing differential processing. Therefore, it is possible to suppress problems of deteriorating signal transmission characteristics specific to differential processing such as a shortage of light-emitting current due to time constant restrictions, waveform distortion due to a pattern effect, and occurrence of excessive pulses due to inrush current during burst operation. Since the pulse widths of the first and second electric pulse signals generated by the transmitting circuit 2 are smaller than the minimum pulse width of the digital electric input signal, the transmitting circuit 2 can also be referred to as a “short pulse generation circuit.” The transmitting circuit 2 (or a part thereof) can be implemented by a driver IC composed of one IC chip. In that case, a different circuit (function) may also be included in the driver IC. For example, the signal input part of the driver IC may also include a parallel-serial signal input conversion circuit.

The first and second light-emitting elements 3 and 4 may be composed of separate parts or may be a light-emitting element array on which the two elements are integrated on one wafer. The first and second optical transmission paths 5 and 6 may be optical fibers or optical waveguides. The first and second light-receiving elements 7 and 8 may also be composed of separate parts or may be a light-receiving element array on which the two elements are integrated on one wafer.

The receiving circuit 10 includes an amplification circuit 11 in which a voltage on a connection path between the anode of the first light-receiving element 7 and the cathode of the second light-receiving element 8 is applied to an input end, and which amplifies the applied voltage. The amplification circuit 11 is composed of, for example, a CMOS circuit and the input end thereof includes a capacitative load. The input end of the amplification circuit 11 is charged by a received current of the first light-receiving element 7 that receives the first optical signal corresponding to the first electric pulse signal synchronized with the rising edge and discharged by a received current of the second light-receiving element 8 that receives the second optical signal corresponding to the second electric pulse signal synchronized with the falling edge. In this way, a pulse voltage waveform having the same logic information as that of the digital electric input signal is generated at the input end of the amplification circuit 11. A digital electric output signal is generated by amplifying this voltage waveform at the amplification circuit 11. The receiving circuit 10 (or part thereof) can be realized by a receiver IC composed of one IC chip. In such a case, a different circuit (function) may also be included in the receiver IC. For example, the signal output section of the receiver IC may also include a serial-parallel signal output conversion circuit.

FIG. 2 shows signal waveforms of the digital electric input signal A, first electric pulse signal B, second electric pulse signal C and digital electric output signal D. As shown in the figure, the first electric pulse signal B is a short pulse synchronized with the rising edge of the digital electric input signal A. The second electric pulse signal C is a short pulse synchronized with the falling edge of the digital electric input signal A. The digital electric output signal D generates a pulse that rises in synchronization with the rising edge of the first electric pulse signal B and falls in synchronization with the rising edge of the second electric pulse signal C. This causes the digital electric output signal D to become a signal equivalent to the digital electric input signal A.

In the actual operation, since it takes a certain time to generate/transmit signals in the respective circuits, for example, generate the first and second electric pulse signals, generate and transmit the first and second optical signals, generate the third and fourth electric pulse signals and generate the digital electric output signal, timings of signals at the respective nodes may not always be those shown in FIG. 2. However, since such timing differences are irrelevant of the essence of the present invention, the timing differences will be ignored hereinafter except for specified cases to be referred.

In this way, according to the first embodiment, since only information of the rising edge and falling edge of a digital electric input signal is transmitted as first and second optical signals via dedicated first and second optical transmission paths 5 and 6 to the receiving circuit 10, the light-emitting frequencies and light-emitting times of the first and second light-emitting elements 3 and 4 can be reduced, thereby reducing the optical power.

In the present embodiment, a delayed signal resulting from delaying the digital electric input signal by a time shorter than the minimum pulse width of the digital electric input signal is combined with the digital electric input signal to generate the first and second electric pulse signals having a pulse width equivalent to the delay time. If the digital electric input signal is delayed by a time equal to or longer than the minimum pulse width of the digital electric input signal, there is no more time overlap between the digital electric input signal and delayed signal in the same minimum pulse (1-bit single pulse) (e.g., simultaneously with or after a fall of a certain minimum pulse in the digital electric input signal, the same minimum pulse rises in the delayed signal), and therefore it is difficult to combine the pulses. Furthermore, in this case, the second optical signal corresponding to the falling edge is generated before the first optical signal corresponding to the rising edge of the digital electric input signal falls, and a time overlap occurs between both signals, and therefore it is also difficult to generate the digital electric output signal in the receiving circuit. As a result, the transmitting circuit and receiving circuit become more complicated, which causes an increase of jitter noise or increase in the area of the circuit. The present embodiment generates the first and second electric pulse signals using a delayed signal resulting from delaying the digital electric input signal by a time shorter than the minimum pulse width of the digital electric input signal, and therefore the above described problem does not occur.

When the above described delay time is substantially the same as the minimum pulse width of the digital electric input signal, the pulse widths of the first and second electric pulse signals become substantially the same as the minimum pulse width of the digital electric input signal. In this case, when the minimum pulse of the digital electric input signal is transmitted, the total of the pulse widths of the first and second electric pulse signals becomes equivalent to minimum pulse 2 bits of the digital electric input signal, resulting in a situation in which the signal transmission energy corresponding to 2 bits is consumed for signal transmission of 1 bit, which is the reverse of low power consumption. However, NRZ signals are generally used for digital signals used in a logic circuit such as an LSI, there is no rising edge or falling edge between bits of contiguous bit data (“1111 . . . ”, “0000 . . . ”), and pulse signal transmission between those edges is not necessary. Therefore, in this case, when the average contiguous bit length of the digital electric input signal is two bits or more, it is possible to reduce power consumption more than in general optical wiring that optically transmits the digital electric input signal itself. Furthermore, since the pulse widths of the first and second electric pulse signals are substantially the same as the minimum pulse width of the digital electric input signal, it is possible to increase the bit rate of the digital electric input signal to a maximum transmission band of the optical wiring path (path from the first and second light-emitting elements 3 and 4 through the first and second optical transmission paths 5 and 6 to the first and second light-receiving elements 7 and 8) and secure a high transmission band while reducing power consumption.

The present embodiment transmits rising edge information and falling edge information of the digital electric input signal through separate optical transmission paths. Because of this, it is possible to easily identify whether the transmitted optical pulse corresponds to the rising edge or the falling edge of the digital electric input signal. Therefore, even if the receiving side fails to receive one or a plurality of optical pulses due to the influence of noise for example, it is possible to correctly generate a digital electric output signal if subsequent optical pulses are received. Moreover, even if the pulse width of the digital electric input signal is small, there is no possibility that the optical pulse corresponding to the rising edge and the optical pulse corresponding to the falling edge may interfere with each other.

The transmitting circuit 2 of the present embodiment generates the first and second electric pulse signals without performing differential processing and causes no such problems as a shortage of light-emitting current due to time constant restrictions or waveform distortion due to a pattern effect or further occurrence of excessive pulses due to inrush current during burst operation, and therefore the voltage amplitudes of the first and second electric pulse signals are quite stable so that transmission errors can be prevented.

In the present embodiment, the electric line to apply the first electric pulse signal corresponding to the rising edge to the first light-emitting element 3 is provided separately from the electric line to apply the second electric pulse signal corresponding to the falling edge to the second light-emitting element 4. Therefore, the anodes of the first and second light-emitting elements 3 and 4 are independent of each other as circuitry, and bias currents can be independently supplied to both light-emitting elements. Compared to a case where light-emitting elements are connected in series as in the case of the circuits shown in Patent Documents 1 and 2, it is possible to lower a power supply voltage necessary to obtain a desirable bias current to be reduced to about half (e.g., 1.5 to 2.0 V), thereby constituting an optical wiring system driven by only a power supply voltage supplied to a normal electronic device.

The first embodiment uses a delayed signal resulting from delaying the digital electric input signal by a time shorter than the minimum pulse width of the digital electric input signal. The following effect can be obtained by setting the delay time of the delayed signal to ½ or less of the minimum pulse width of the digital electric input signal.

When the delay time of the delayed signal is set to ½ or less of the minimum pulse width of the digital electric input signal, the pulse width of the first electric pulse signal synchronized with the rising edge of the digital electric input signal and the pulse width of the second electric pulse signal synchronized with the falling edge become half or less of the minimum pulse width of the digital electric input signal. Therefore, even when the minimum pulse (1-bit single pulse) of the digital electric input signal is transmitted, the total of the pulse width of the first electric pulse signal synchronized with the rising edge and the pulse width of the second electric pulse signal synchronized with the falling edge becomes equivalent to or below the minimum pulse 1 bit of the digital electric input signal. Therefore, it is possible to reduce power consumption, compared to usual optical wiring that optically transmits digital electric input signal of all the bit patterns itself. In this case, however, the bit rate of the digital electric input signal is limited to ½ or less of the maximum transmission band of the optical wiring path (path from the first and second light-emitting elements 3 and 4 through the first and second optical transmission paths 5 and 6 to the first and second light-receiving elements 7 and 8). However, the present embodiment can obtain a large effect in applications requiring reduction of power consumption rather than a maximum bit rate while requiring the high transmission quality of optical wiring (e.g., anti electromagnetic noise characteristic), for example, in a battery-driven mobile devices. The effect is, for example, long continuous drive time.

In this way, the delay time of the delayed signal used to generate the first and second electric pulse signals may be preferably selected as appropriate according to the application and optimal values may be preferably set according to the device or system in which the complementary optical wiring apparatus according to the present embodiment is incorporated. For the digital device using an NRZ signal which is generally used in a logic circuit such as LSI in particular, it may be possible to reduce power consumption by reducing the delay time of the delayed signal to a minimum pulse width (corresponding to 1 bit) or below of the digital electric input signal.

### Second Embodiment

A second embodiment is a more specific example of the first embodiment.

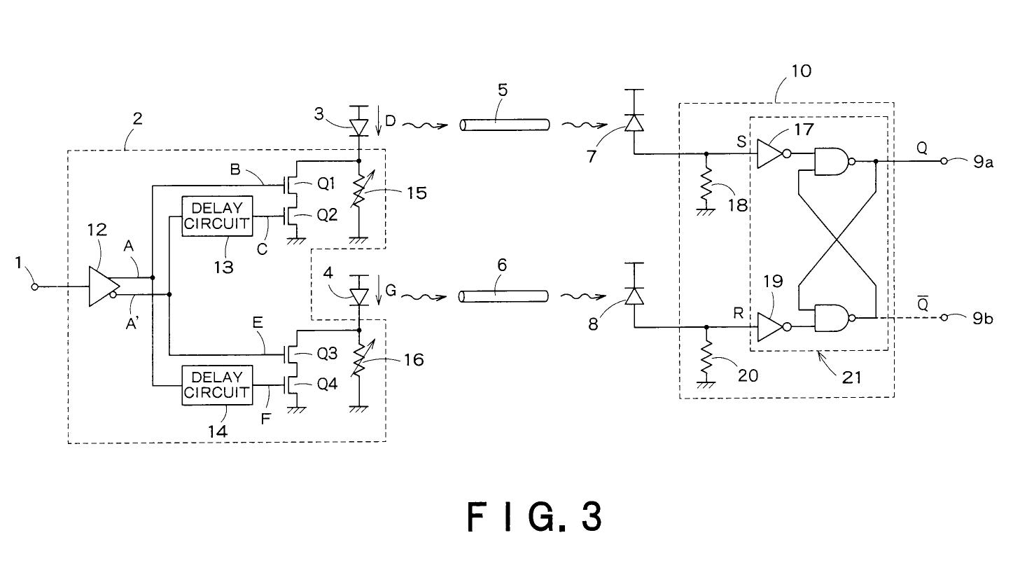

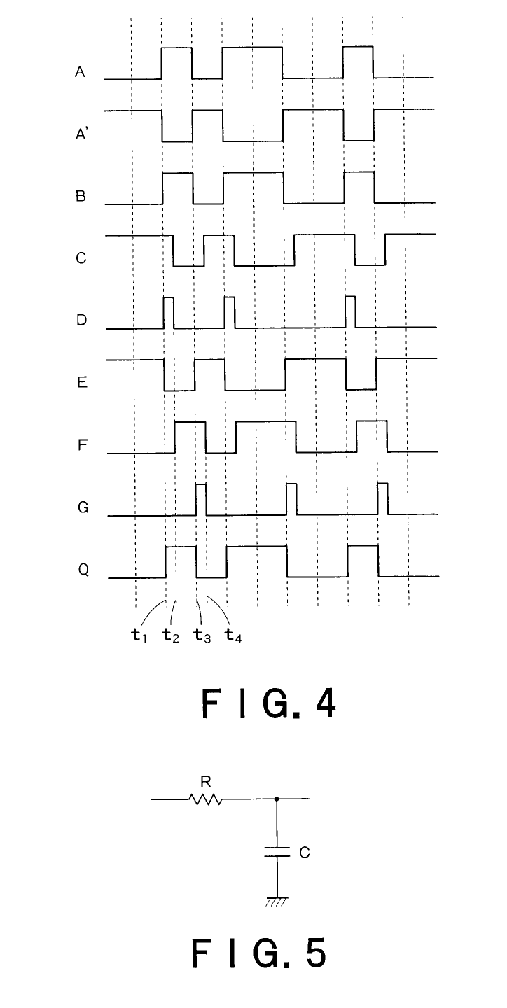

FIG. 3 is a circuit diagram showing a schematic configuration of a complementary optical wiring system according to a second embodiment of the present invention, and FIG. 4 is timing charts of the respective parts shown in FIG. 3. In FIG. 3, components common to those in FIG. 1 are assigned the same reference numerals and the following explanations will be focused on the differences.

One of the features of the complementary optical wiring system in FIG. 3 is the internal configurations of the transmitting circuit 2 and the receiving circuit 10. The transmitting circuit 2 in FIG. 3 includes a differential conversion buffer 12, first and second delay circuits 13 and 14, NMOS transistors Q1 and Q2, a resistance element 15 (first impedance adjuster), NMOS transistors Q3 and Q4, and a resistance element 16 (second impedance adjuster).

The differential conversion buffer 12 converts a digital electric input signal which is a single signal (single end signal) to a differential signal. The first and second delay circuits 13 and 14 delay a pair of signals constituting the differential signal. The MOS transistors Q1 and Q2 connected serially generate a first electric pulse signal. The resistance element 15 supplies a bias current to the first light-emitting element 3. The MOS transistors Q3 and Q4 connected in series generate a second electric pulse signal. The resistance element 16 supplies the second light-emitting element 4 with a bias current.

The differential conversion buffer 12 outputs a signal of the same logic as the digital electric input signal from the first differential output terminal and outputs an inverted signal of the digital electric input signal from the second differential output terminal.

The first delay circuit 13 delays a signal A′ outputted from the second differential output terminal and the second delay circuit 14 delays a signal A outputted from the first differential output terminal. The first and second delay circuits 13 and 14 can be composed of an RC delay circuit having a resistance element R and a capacitor C as shown in FIG. 5, or can be composed of a buffer circuit having an even-number of serially connected inverter circuits, for example but the specific circuit configuration is not particularly limited.

The MOS transistors Q1 and Q2 are serially connected between the cathode of the first light-emitting element 3 and a grounding terminal, the gate of the MOS transistor Q1 is connected to the first differential output terminal and the gate of the MOS transistor Q2 is connected to the output terminal of the first delay circuit 13.

The MOS transistors Q3 and Q4 are serially connected between the cathode of the second light-emitting element 4 and a grounding terminal and the gate of the MOS transistor Q3 is connected to the second differential output terminal and the gate of the MOS transistor Q4 is connected to the output terminal of the second delay circuit 14.

The resistance element 15 is connected between the cathode of the first light-emitting element 3 and the grounding terminal, and the resistance element 16 is connected between the cathode of the second light-emitting element 4 and the grounding terminal. These resistance elements 15 and 16 are intended to pass a bias current through the first and second light-emitting elements 3 and 4. The bias current may be on the order of such a level (e.g., 100 μA) where the voltage difference between the anode and cathode of the first and second light-emitting elements 3 and 4 become ON-voltages (current rising voltages) of the first and second light-emitting elements 3 and 4. Therefore, it is possible to reduce the impedance of the first and second light-emitting elements 3 and 4, to, for example, 1/10 of the impedance when no bias current is supplied, and to reduce the driving loads of the MOS transistors Q1 to Q4 that control light emission of the first and second light-emitting elements 3 and 4, thereby performing modulation processing in a relatively linear differential resistance region above the region where the diode currents of the first and second light-emitting elements 3 and 4 rise. The resistance elements 15 and 16 may be fixed resistors or variable resistors. When the resistance elements 15 and 16 are variable resistors, it is possible to adjust the amount of current required for light emission or intensity of light emission by controlling the amount of bias current.

As shown in FIG. 4, when the signals A and B (both are equivalent to the digital electric input signal) outputted from the first differential output terminal changes from low to high at time t1, an output C of the first delay circuit 13 changes from high to low at time t2, which is later than time t1. In this case, both the MOS transistors Q1 and Q2 only turn ON between times t1 and t2 and a current (first electric pulse signal) D flows through the MOS transistors Q1 and Q2. This current causes the first light-emitting element 3 to generate an optical short pulse (first optical signal).

Furthermore, when the digital electric input signal A changes from high to low at time t3 (when the signals A′ and E change from low to high), an output F of the second delay circuit 14 changes from high to low at time t4, which is later than time t3. In this case, both the MOS transistors Q3 and Q4 turn ON only between times t3 to t4 and a current (second electric pulse signal) G flows through the MOS transistors Q3 and Q4. This current causes the second light-emitting element 4 to generate an optical short pulse (second optical signal).

The receiving circuit 10 in FIG. 3 includes a resistance element 18 connected to the anode of a first light-receiving element 7, a resistance element 20 connected to the anode of a second light-receiving element 8 and an SR flip flop 21. The resistance elements 18 and 20 are intended to convert currents flowing through the first and second light-receiving elements 7 and 8 to voltages.

The SR flip flop 21 is composed of, for example, two inverter circuits 17 and 19 and two NAND circuits as shown in FIG. 3. The inverter circuit 17 inverts a signal inputted to an input terminal S, and the inverter circuit 19 inverts a signal inputted to an input terminal R. In the SR flip flop 21, when the signal inputted to the input terminal S changes from low to high, the signal outputted from an output terminal Q changes from low to high (referred to as “set operation”), and when the signal inputted to the input terminal R changes from low to high, the signal outputted from the output terminal Q changes from high to low (referred to as “reset operation”). Therefore, the output terminal Q of the SR flip flop 21 becomes high when the third electric pulse signal becomes high and becomes low when the fourth electric pulse signal becomes high. The signal outputted from an output terminal 9a in this way is the digital electric output signal.

The output of the receiving circuit 10 may be a single end output with only the output signal of the Q terminal of the SR flip flop 21, but when the SR flip flop 21 is provided with both the Q terminal and /Q (inverted Q) terminal, an inverted signal of the digital electric output signal may be outputted from the /Q terminal 9b together with the digital electric output signal (dotted line in FIG. 3). In this case, a digital electric output signal is obtained at the differential output.

Although FIG. 3 shows an example where the digital electric input signal inputted to the transmitting circuit 2 is a single end signal, this may also be a differential signal. In this case, the differential conversion buffer 12 is not necessary. Alternatively, a differential buffer that amplifies the digital electric input signal of the differential signal may also be provided instead of the differential conversion buffer 12. When a differential signal is inputted as the digital electric input signal, a differential signal is also used as the digital electric output signal under normal conditions, but a single end signal may also be used as the digital electric output signal.

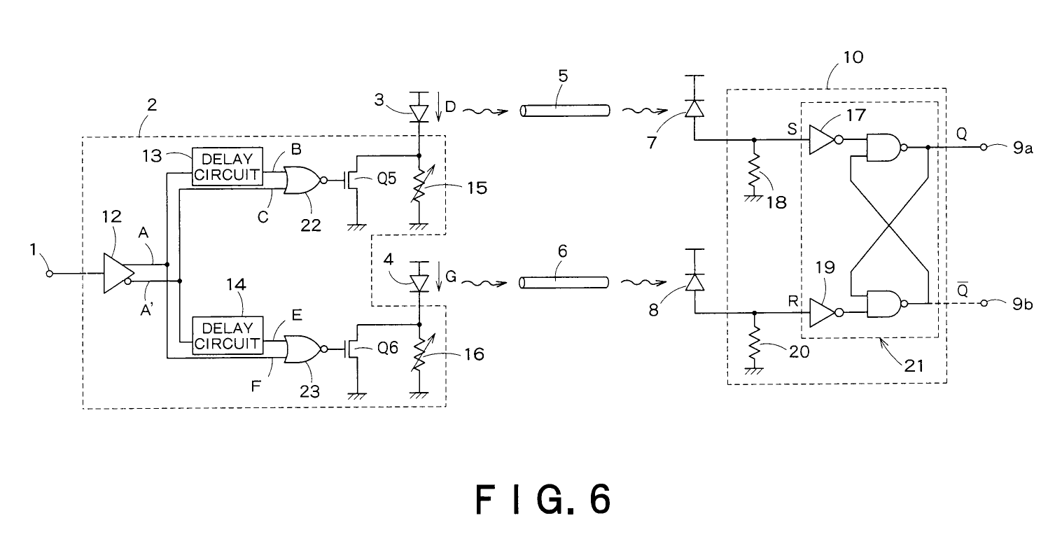

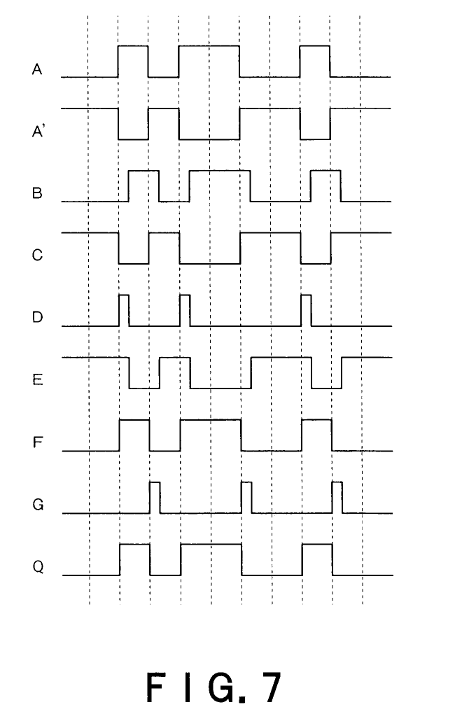

FIG. 3 shows an example where two transistors are driven with a delay time difference, but it is also possible to generate a first or second electric pulse signal by only one transistor. For example, FIG. 6 is a circuit diagram showing a schematic configuration of a complementary optical wiring system showing a modification example of FIG. 3, and FIG. 7 is timing charts of the respective parts shown in FIG. 6. In the system in FIG. 6, the internal configuration of the transmitting circuit 2 is different from FIG. 3 and the rest is the same as FIG. 3. The transmitting circuit 2 in FIG. 6 includes a differential conversion buffer 12, first and second delay circuits 13 and 14, NOR circuits 22 and 23, and NMOS transistors Q5 and Q6.

The first delay circuit 13 delays a signal A (equivalent to a digital electric input signal) outputted from the first differential output terminal of the differential conversion buffer 12. The NOR circuit 22 outputs a signal resulting from performing a NOR operation between an output signal B of the first delay circuit 13 and a signal C(A′) (inverted digital electric input signal) outputted from the second differential output terminal of the differential conversion buffer 12. The NOR circuit 22 outputs high when both the output signal B of the first delay circuit 13 and the inverted signal C of the digital electric input signal are low.

The second delay circuit 14 delays a signal A′ outputted from the second differential output terminal. The NOR circuit 23 outputs a signal resulting from performing a NOR operation between an output signal E of the second delay circuit 14 and a signal F(A) (equivalent to the digital electric input signal) outputted from the first differential output terminal. The NOR circuit 23 outputs high when both the output signal E of the second delay circuit 14 and the signal F equivalent to the digital electric input signal are low.

The output signal of the NOR circuit 22 is inputted to the gate of the MOS transistor Q5, and the output signal of the NOR circuit 23 is inputted to the gate of the MOS transistor Q6. This causes the MOS transistor Q5 to turn ON for only a short period from the rising edge of the digital electric input signal, in order to generate a first electric pulse signal D and a first optical signal, and causes the MOS transistor Q6 to turn ON for a short period from the falling edge of the digital electric input signal, in order to generate a second electric pulse signal G and a second optical signal.

Consequently, the circuit in FIG. 6 operates at timings similar to timings in FIG. 3 and the effects obtained are also the same.

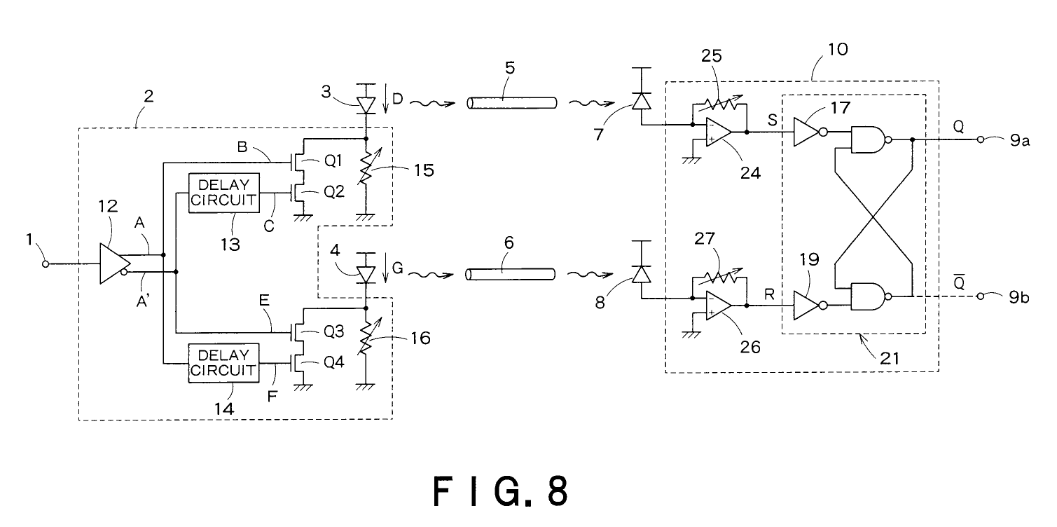

FIG. 3 and FIG. 6 show examples where a received current is converted to a voltage by resistance elements, that is, the receiving circuit 10 is composed of a so-called high impedance circuit. It is also possible to adopt a trans-impedance circuit composed of an amplifier and a negative feedback resistance element. For example, FIG. 8 is a modification example of FIG. 3 and is a circuit diagram showing a schematic configuration when the receiving circuit 10 has a trans-impedance configuration. The receiving circuit 10 in FIG. 8 includes an operational amplifier 24 and a resistance element 25, instead of the resistance element 18. The anode of the first light-receiving element 7 is connected to the negative side input terminal 1 of the operational amplifier 24. The resistance element 25 is inserted between input and output terminals of the operational amplifier 24. Furthermore, the receiving circuit 10 in FIG. 8 includes an operational amplifier 26 and a resistance element 27, instead of the resistance element 20. The anode of the second light-receiving element 8 is connected to the negative side input terminal 1 of the operational amplifier 26. The resistance element 27 is inserted between input and output terminals of the operational amplifier 26. Both positive side input terminals of the operational amplifiers 24 and 26 are grounded.

As shown above, the receiving circuit 10 in FIG. 8 realizes a trans-impedance scheme by providing the operational amplifier 24, resistance element 25, operational amplifier 26 and resistance element 27. The trans-impedance scheme is characterized in that a signal gain is determined by the resistance values of the resistance elements 25 and 27, wider band operation than the high impedance scheme in FIG. 3 is possible and less noise is produced.

The receiving circuit 10 in FIG. 6 can also be modified to a receiving circuit 10 based on the trans-impedance scheme as in the case of FIG. 8.

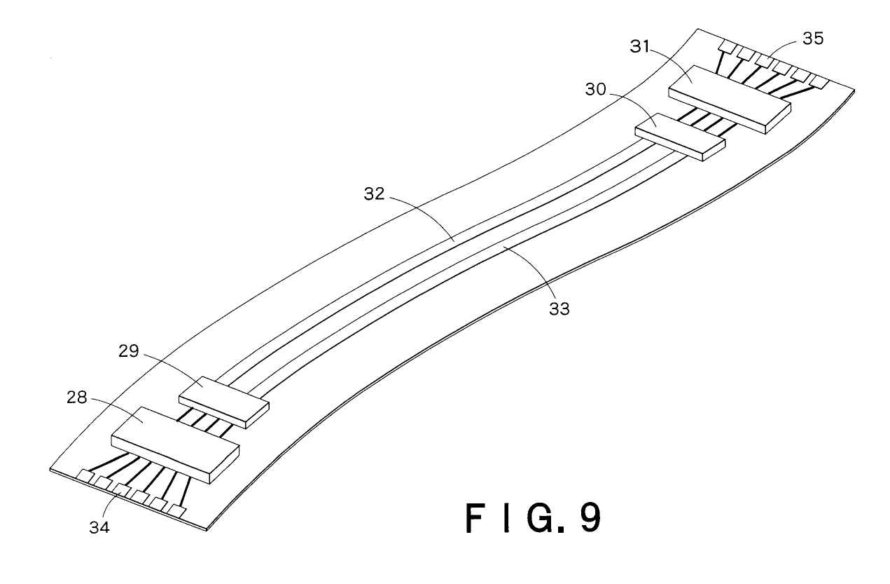

FIG. 9 is a perspective view showing an example of a complementary optical wiring module mounted with the system in FIG. 3 or FIG. 6. The module in FIG. 9 is provided with a transmitting side driver IC 28 incorporating the transmitting circuit 2 mounted on a flexible printed substrate (FPC: Flexible Printed Circuits), a light-emitting element array 29 incorporating the first and second light-emitting elements 3 and 4, a light-receiving element array 30 incorporating the first and second light-receiving elements 7 and 8 and a receiving side receiver IC 31 incorporating the receiving circuit 10.

The first and second optical transmission paths 5 and 6 between the light-emitting element array 29 and the light-receiving element array 30 are formed of first and second optical waveguides 32 and 33, respectively. The total length of the first and second optical waveguides 32 and 33 is, for example, 10 to 20 cm. At both ends of the FPC, there are a plurality of contact terminals 34 connected to the transmitting side driver IC 28 and a plurality of contact terminals 35 connected to the receiving side receiver IC 31. These contact terminals 34 and 35 are connected to connectors (not shown) or connected to another circuit substrate by means of wire bonding or solder.

The shape of the FPC can be modified arbitrarily, but it is possible to manufacture the FPC so that even if the FPC is bent or twisted by a large amount, the first and second optical signals propagating through the first and second optical waveguides 32 and 33 are not shut off, weakened in optical intensity or do not include noise. Therefore, by adopting the mounting mode as shown in FIG. 9, it is possible to construct a small and thin system, and to reduce the manufacturing cost. Therefore, the present embodiment is widely applicable to high-speed signal wiring of the movable part in a small electronic device such as a mobile phone.

### Third Embodiment

A third embodiment shows a more specific example of the transmitting circuit 2 of the first embodiment (FIG. 1).

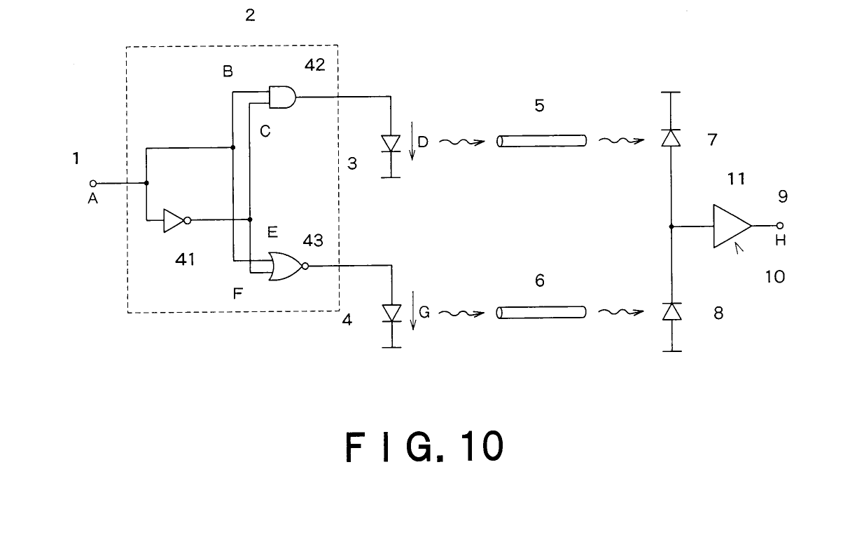

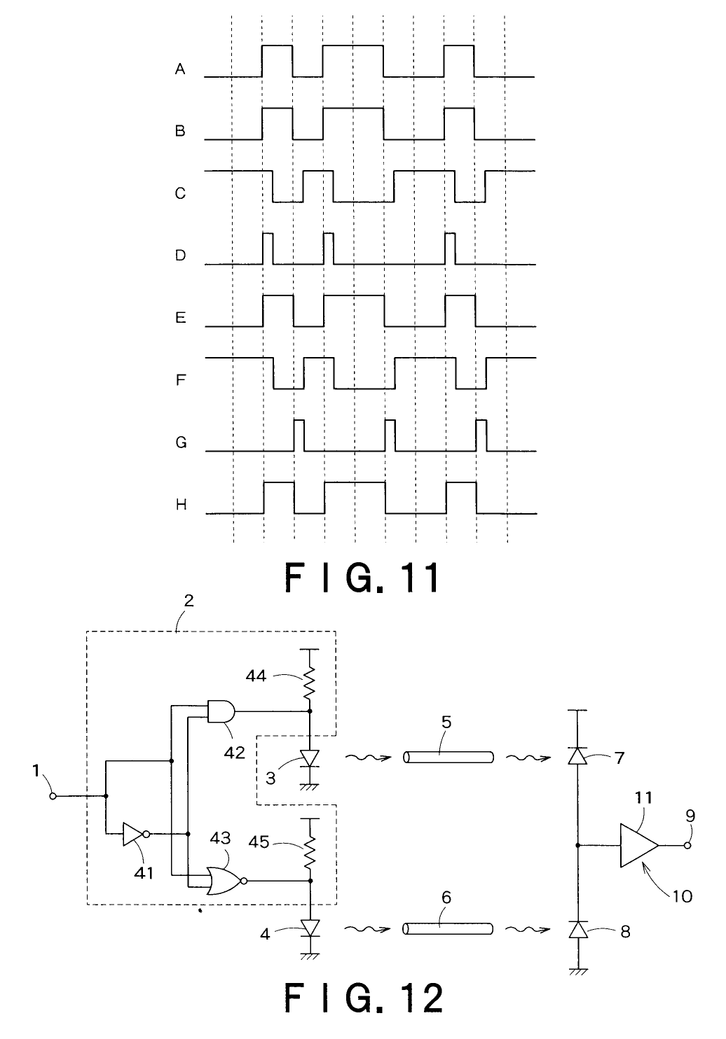

FIG. 10 is a circuit diagram showing a schematic configuration of a complementary optical wiring system according to the third embodiment of the present invention, and FIG. 11 is timing charts of the respective parts shown in FIG. 10. The system in FIG. 10 is configured in the same way as in FIG. 1 except in that the internal configuration of the transmitting circuit 2 is different from FIG. 1.

The transmitting circuit 2 in FIG. 10 includes an inverter circuit 41 (logic inversion circuit), an AND circuit 42 (logic operation circuit) and a NOR circuit 43 (logic operation circuit). The inverter circuit 41 generates delayed signals C and F resulting from inverting and delaying the digital electric input signals A, B and E. The AND circuit 42 calculates a logic product of the digital electric input signal and the delayed signal. The NOR circuit 43 performs a NOR operation between the digital electric input signal and the delayed signal. The delay time of the delayed signal is determined by a signal transmission time of the inverter circuit 41. That is, the inverter circuit 41 also functions as a delay circuit here.

The AND circuit 42 generates a first electric pulse signal D having a pulse width corresponding to the delay time of the inverter circuit 41 in synchronization with the rising edge of the digital electric input signal A. The NOR circuit 43 generates a second electric pulse signal G having a pulse width corresponding to the delay time of the inverter circuit 41 in synchronization with the falling edge of the digital electric input signal. The first light-emitting element 3 generates an optical short pulse (first optical signal) in synchronization with the first electric pulse signal, and the second light-emitting element 4 generates an optical short pulse (second optical signal) in synchronization with the second electric pulse signal.

In this way, according to the third embodiment, the delayed signal is generated using the signal transmission time through the inverter circuit 41. The delay time can be optimized by adjusting the transistor size (gate width) inside the inverter circuit 41 and/or the number of connected inverter circuits. However, when a plurality of inverter circuits are connected, it should be noted that the logic varies depending on whether the number of connected inverter circuits is an even number or odd number, and therefore the circuitry may not operate correctly. The RC delay circuit shown in FIG. 5 may also be used as the delay circuit instead of the inverter circuit 41, but since the logic is not inverted in that case, an inverter circuit separately needs to be connected to invert the logic.

In FIG. 10, the AND circuit 42 and the NOR circuit 43 are arranged at subsequent side of the inverter circuit 41, but since signal transmission times of both circuits are different, there is a possibility that a difference may be produced in timing at which first and second electric pulse signals are generated and jitter may increase in the digital electric output signal. To avoid this problem, it is desirable to reduce jitter by adjusting the sizes of the respective MOS transistors constituting the inverter circuit 41, AND circuit 42 and NOR circuit 43, and by connecting load capacitance and load resistance elements to the input part of each MOS transistor.

FIG. 12 is a circuit diagram showing a modification example of FIG. 10. In FIG. 12, resistance elements 44 and 45 are connected between the anodes of the first and second light-emitting elements 3 and 4 and power supply terminals. These resistance elements 44 and 45 are intended to supply bias currents to the first and second light-emitting elements 3 and 4 individually. The bias currents supplied by the resistance elements 44 and 45 may be on the order of such a level (e.g., 100 μA), as described in the second embodiment, where the anode voltages of the first and second light-emitting elements 3 and 4 become ON-voltages (current rising voltages) of the first and second light-emitting elements 3 and 4.

### Fourth Embodiment

In a fourth embodiment, an internal configuration of the transmitting circuit 2 is different from that of the third embodiment (FIG. 10).

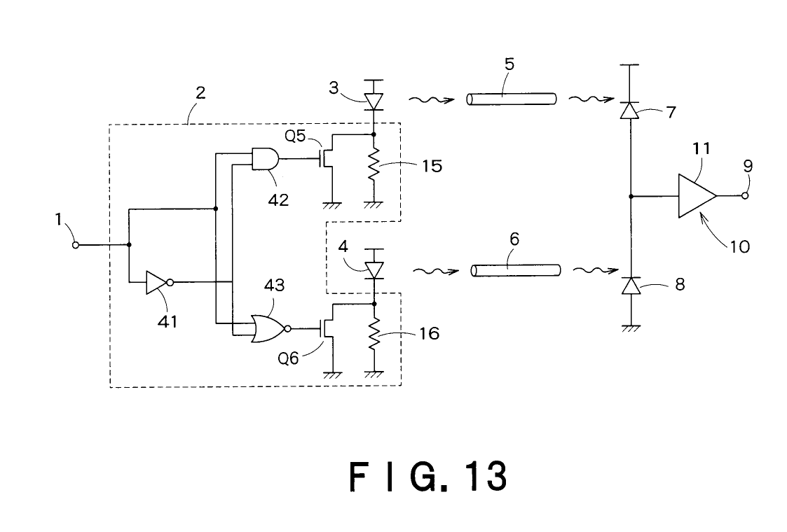

FIG. 13 is a circuit diagram showing a schematic configuration of a complementary optical wiring system according to the fourth embodiment of the present invention. The system in FIG. 13 is configured in the same way as in FIG. 10 except in that the internal configuration of the transmitting circuit 2 is different from that shown in FIG. 10.

The transmitting circuit 2 in FIG. 13 has not only an inverter circuit 41, AND circuit 42 and NOR circuit 43 similar to those in FIG. 10 but also an NMOS transistor Q5 (first switching element) and a resistance element 15 connected in parallel between the cathode of the first light-emitting element 3 and a grounding terminal and an NMOS transistor Q6 (second switching element), and a resistance element 16 connected in parallel between the cathode of the second light-emitting element 4 and a grounding terminal.

An output terminal (first intermediate pulse signal) of the AND circuit 42 is connected to the gate of the NMOS transistor Q5, and an output terminal of the NOR circuit 43 (second intermediate pulse signal) is connected to the gate of the NMOS transistor Q6.

The NMOS transistors Q5 and Q6 function as amplification circuits that supplement currents to be supplied to the first and second light-emitting elements 3 and 4. Since the NMOS transistors Q5 and Q6 perform operations to pull in currents from the first and second light-emitting elements 3 and 4, the positional relationship between the first light-emitting element 3 and the resistance element 15 is the reverse of the positional relationship between the second light-emitting element 4 and resistance element 16 in FIG. 12.

The output loads of the AND circuit 42 and NOR circuit 43 in FIG. 13 are only the gate capacitances of the NMOS transistors Q5 and Q6, and are smaller than the output loads (those of the light-emitting elements 3 and 4) in FIG. 10 and FIG. 12. Therefore, it is possible not only to reduce the sizes of MOS transistors (not shown) constituting the AND circuit 42 and NOR circuit 43 compared to FIG. 10 and FIG. 12 but also to supply sufficient currents to the first and second light-emitting elements 3 and 4, improve the light-emitting intensity, and improve the stability and reliability of optical transmission.

The NMOS transistors Q5 and Q6 may be replaced by PMOS transistors, but in this case, it is preferable to arrange the resistance elements 15 and 16 on the power supply terminal side, arrange the first and second light-emitting elements 3 and 4 on the grounding side (so that the cathode is connected to the grounding terminal), and connect the sources of the PMOS transistors to the power supply terminals, and connect the drains to the connection nodes between the cathodes of the first and second light-emitting elements 3, 4 and the resistance elements 15, 16. Furthermore, since the PMOS transistor turns ON/OFF by the reverse logic of the NMOS transistor, it is preferable to provide a NAND circuit instead of the AND circuit 42 and an OR circuit instead of the NOR circuit 43.

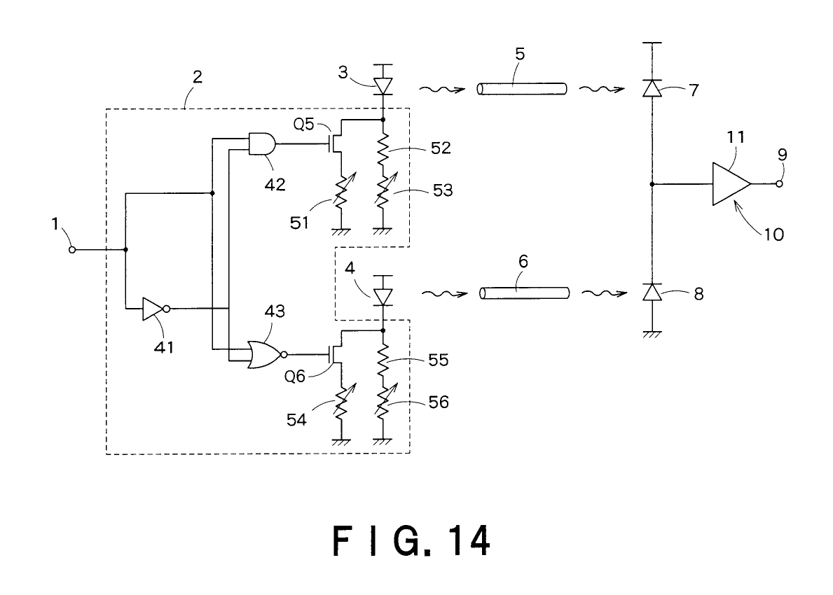

At least one of the resistance elements 15 and 16 in FIG. 10, FIG. 12 or FIG. 13 may be a variable resistance element and further (or) a variable resistance element may be inserted between the source of the NMOS transistors Q5 and Q6 and grounding terminal. For example, FIG. 14 is a circuit diagram showing a modification example of FIG. 13. The transmitting circuit 2 in FIG. 14 includes a variable resistance element 51 (first variable resistance element) connected between the source of the NMOS transistor Q5 (first switching element) and the grounding terminal (reference voltage terminal), a resistance 52 and a variable resistance element 53 connected in series between the drain of the NMOS transistor Q5 and the grounding terminal, a variable resistance element 54 (second variable resistance element) connected between the source of the NMOS transistor Q6 (second switching element) and the grounding terminal, a resistance 55 and a variable resistance element 56 connected in series between the drain of the NMOS transistor Q6 and the grounding terminal.

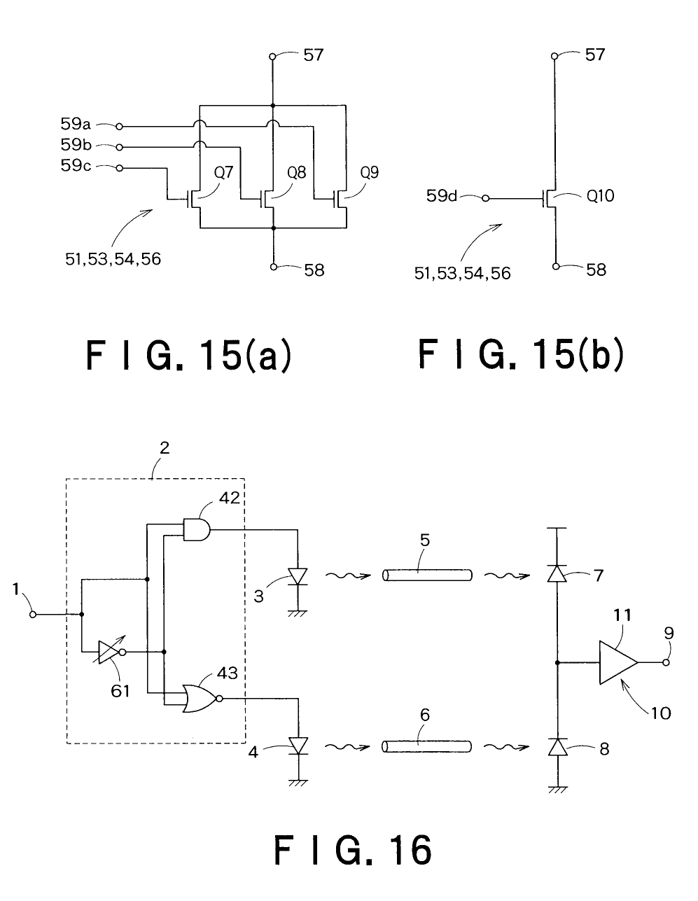

The variable resistance elements 51, 53, 54 and 56 can be formed of, for example, MOS transistors. FIG. 15(a) is a circuit diagram of a variable resistance element composed of three MOS transistors Q7 to Q9, and FIG. 15(b) is a circuit diagram of a variable resistance element composed of only one MOS transistor Q10.

In FIG. 15(a) and FIG. 15(b), two terminals 57 and 58 are both terminals of the variable resistance element, and control terminals 59a to 59d are connected to the gates of the respective MOS transistors Q7 to Q10. In the case of the variable resistance element in FIG. 15(a), it is possible to vary the resistance value of the variable resistance element to a plurality of values by controlling the number of transistors which turn ON among the three MOS transistors Q7 to Q9 by control signals inputted to the control terminals 59a to 59c. In the case of the variable resistance element in FIG. 15(b), it is possible to control the resistance value between the source and drain of the MOS transistor Q10 by controlling the voltage level of a control signal inputted to the control terminal 59d in an analog fashion.

In this way, since the transmitting circuit 2 in FIG. 14 has the variable resistance elements 51, 53, 54 and 56, the amount of bias current and (or) amount of light-emitting current supplied to the first and second light-emitting elements 3 and 4 can be variably controlled. Therefore, it is possible to change operation conditions in such a way that the bias current and drive current are suppressed in a low power consumption mode during low-speed operation, while the bias current and the amount of light-emitting current are increased in a high-speed operation mode, thereby controlling power consumption delicately.

The above described transmitting circuit 2 in FIG. 10, FIG. 12, FIG. 13 and FIG. 14 is provided with an inverter circuit that inverts and delays a digital electric input signal, but a variable delay circuit that can control a delay time may also be provided instead of this inverter circuit.

FIG. 16 is a circuit diagram showing a modification example of FIG. 10. The transmitting circuit 2 in FIG. 16 is configured in the same way as that in FIG. 10 except in that the inverter circuit 41 in FIG. 10 is replaced by a variable delay circuit 61. The variable delay circuit 61 can adjust the signal transmission delay time. Therefore, it is possible to variable control pulse widths of the first and second electric pulse signals.

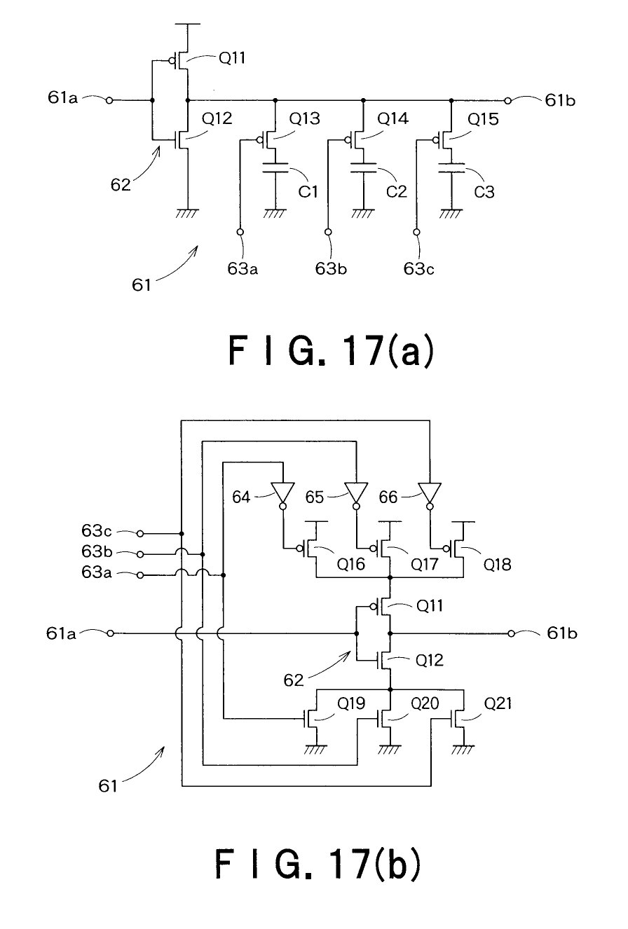

FIG. 17(a) is a circuit diagram showing a first example of the internal configuration of the variable delay circuit 61 in FIG. 16 and FIG. 17(b) is a circuit diagram showing a second example of the internal configuration of the variable delay circuit 61 in FIG. 16. The variable delay circuit 61 in FIG. 17(a) includes input/output terminals 61a and 61b, a PMOS transistor Q11 and an NMOS transistor Q12, three PMOS transistors Q13 to Q15, and capacitors C1 to C3.

The PMOS transistor Q11 and NMOS transistor Q12 constitute an inverter circuit 62. The sources of the PMOS transistors Q13 to Q15 are connected to the output terminal 61b, and the PMOS transistors Q13 to Q15 can control the gate voltages individually. The capacitors C1 to C3 are connected between the drains of the respective PMOS transistors Q13 to Q15 and grounding terminals. The three PMOS transistors Q13 to Q15 and capacitors C1 to C3 are intended to perform variable control over the output capacitance of the inverter circuit 62. Control terminals 63a to 63c are connected to the gates of the respective PMOS transistors Q13 to Q15.

In FIG. 17(a), among the three PMOS transistors Q13 to Q15, the number of the turned-ON PMOS transistors is controlled by control signals inputted to the control terminals 63a to 63c. The output capacitance of the inverter circuit 62 varies depending on whether the PMOS transistors Q13 to Q15 are ON or OFF. This variation of the output capacitance can be regarded as a variation of the gate load at subsequent side of the variable delay circuit 61 (gate capacitance of AND circuit 42 and NOR circuit 43 in FIG. 16). Therefore, the time until the input logic of the AND circuit 42 or NOR circuit 43 changes, that is, the delay time of the variable delay circuit 61, is variably controlled.

The variable delay circuit 61 in FIG. 17(b) includes input/output terminals 61a and 61b, a PMOS transistor Q11 and an NMOS transistor Q12, three PMOS transistors Q16 to Q18, inverter circuits 64 to 66, and three NMOS transistors Q19 to Q21.

The PMOS transistor Q11 and an NMOS transistor Q12 constitute an inverter circuit 62. The PMOS transistors Q16 to Q18 are connected in parallel with the source of the PMOS transistor Q11. The inverter circuits 64 to 66 are connected to the gates of the PMOS transistors Q16 to Q18 respectively. The NMOS transistors Q19 to Q21 are connected in parallel with the source of the NMOS transistor Q12.

Control signals inputted to control terminals 63a to 63c in FIG. 17(b) are supplied to the gates of the three NMOS transistors Q19 to Q21, and inverted by the inverters 64 to 66 and supplied to the gates of the three PMOS transistors Q16 to Q18. Out of PMOS transistors Q16 to Q18 and NMOS transistors Q19 to Q21, the number of the turned-ON transistors is controlled by the control signals, and it is thereby possible to control resistance value of the power supply path and the grounding path of the inverter circuit 62. When the resistance value of the power supply path and the grounding path of the inverter circuit 62 varies, the amount of current supplied to the gate load (gate capacitances of the AND circuit 42 and NOR circuit 43 in FIG. 16) at subsequent side of the variable delay circuit 61 varies, which makes it possible to variably control the time until the input logic of the AND circuit 42 or NOR circuit 43 varies, that is, the delay time of the variable delay circuit 61.

In this way, by variably controlling the pulse widths of the first and second electric pulse signals, it is possible to control the amount of emitted light of the first and second light-emitting elements 3 and 4. It is possible to adopt different utilities such that in the signal transmission where a BER (Bit Error Rate: code error rate) needs to be suppressed to a low level for command transmission of a computer program or the like, the pulse width is increased and the S/N (Signal to Noise) ratio of a digital electric output signal generated on the receiving side is increased, while when a relatively large BER can be allowed as in the case of transmission of a large amount of continuous data, the pulse width is narrowed and power consumption is reduced.

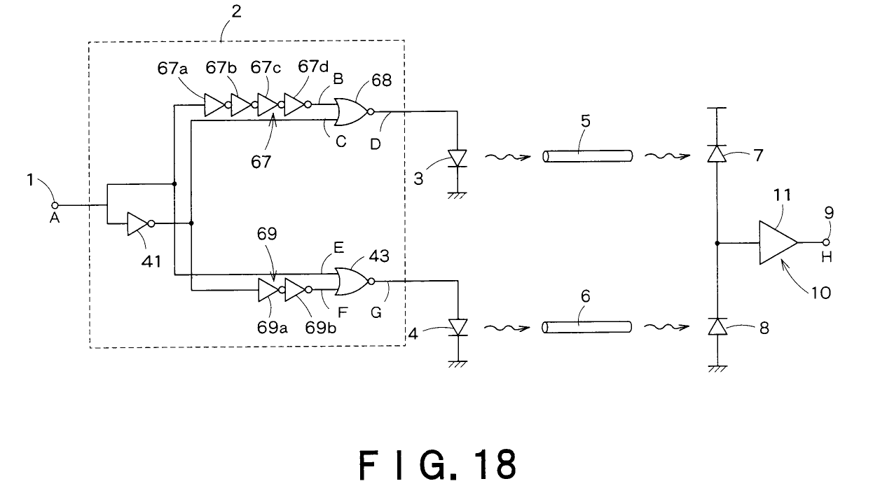

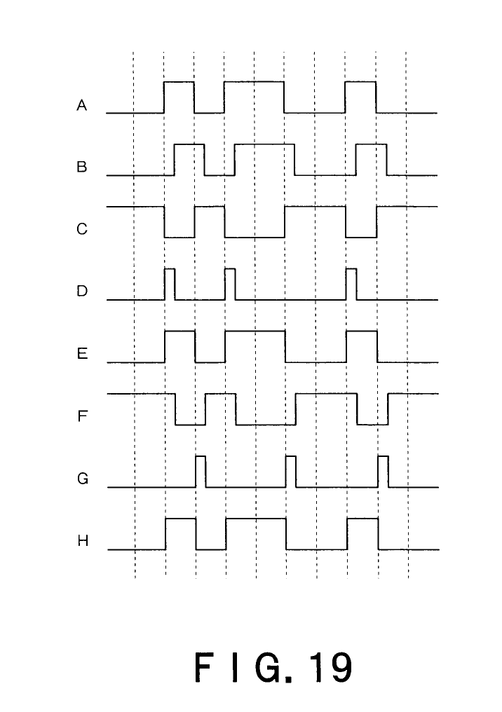

The internal configuration of the above described transmitting circuit 2 shown in FIG. 10, FIG. 12, FIG. 13, FIG. 14 or FIG. 16 can be changed as appropriate. FIG. 18 is a circuit diagram showing a modification example of the internal configuration of the transmitting circuit 2 shown in FIG. 10, FIG. 12, FIG. 13, FIG. 14 or FIG. 16, and FIG. 19 is timing charts of nodes A to H in FIG. 18. The transmitting circuit 2 in FIG. 18 includes, in addition to the inverter circuit 41, a delay circuit 67 and a NOR circuit 68 to generate a first electric pulse signal and a delay circuit 69 and a NOR circuit 43 to generate a second electric pulse signal.

The delay circuit 67 is composed of four serially connected inverter circuits 67a to 67d, and a digital electric input signal is inputted to the initial inverter circuit 67a. The NOR circuit 68 performs a NOR operation between a delayed signal C resulting from inverting and delaying the digital electric input signal A by the inverter circuit 41 and a delayed signal B resulting from delaying the digital electric input signal A by the delay circuit 67, in order to generate a first electric pulse signal D.

The delay circuit 69 is composed of two serially connected inverter circuits 69a and 69b, and a delayed signal resulting from inverting and delaying the digital electric input signal A is inputted to the initial inverter circuit 69a. The NOR circuit 43 performs a NOR operation between the digital electric input signal A(E) and a delayed signal F resulting from inverting and delaying the digital electric input signal by the inverter circuit 41 and further delaying the inverted and delayed signal by the delay circuit 69, in order to generate a second electric pulse signal G.

As shown in FIG. 19, both the first electric pulse signal D and the second electric pulse signal G have the same pulse width, and the pulse width is equivalent to a signal transmission delay time corresponding to the three inverter circuits, which is a delay difference between the two signals inputted to the NOR circuits 68 and 43 respectively. The pulse widths of the first and second electric pulse signals can be arbitrarily set by adjusting the number of inverter circuits connected in the delay circuits 67 and 69.

The two input signals of the NOR circuit 68 pass through one more inverter circuit than the two input signals of the NOR circuit 43, and the first electric pulse signal has a greater total amount of delay than that of the second electric pulse signal, which may lead to an increase of jitter in the digital electric output signal. To avoid such an increase of jitter, it is preferable to adjust the sizes of the respective MOS transistors constituting the inverter circuits 67a to 67d, 69a and 69b and NOR circuits 43 and 68, or to connect a load capacitance or load resistance element to the input parts of the respective MOS transistors, thereby suppressing jitter.

As described above, the internal circuit configuration of the complementary optical wiring system according to the first to fourth embodiments can be modified in various ways.

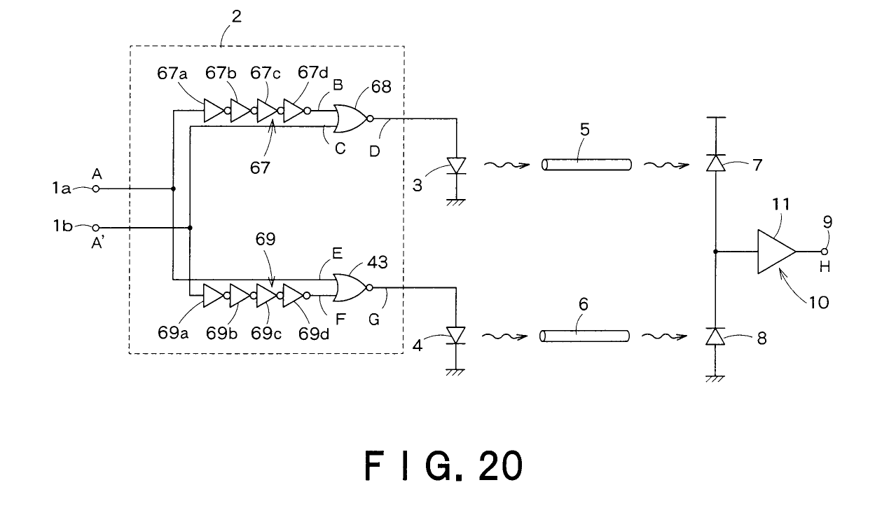

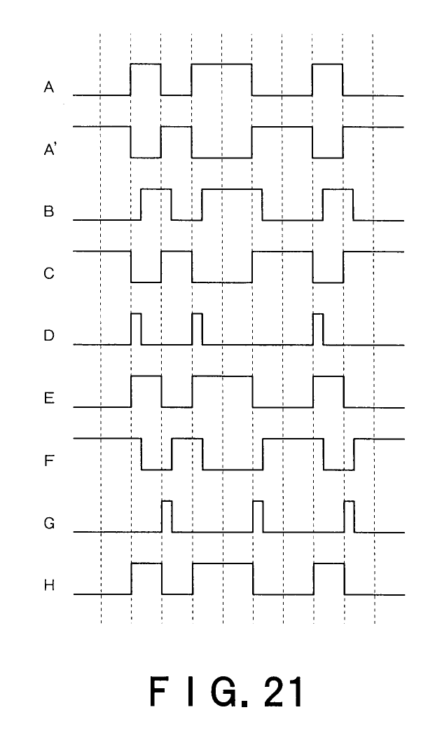

Examples have been explained in the above described first to fourth embodiments, in which a single end digital electric input signal is inputted to the transmitting circuit 2, but a differential digital electric input signal may also be inputted to the transmitting circuit 2. For example, FIG. 20 is a circuit diagram showing a schematic configuration of a complementary optical wiring system showing an example where a differential digital electric input signal is inputted to the transmitting circuit 2, and FIG. 21 is timing charts of nodes A to H in FIG. 20. The transmitting circuit 2 in FIG. 20 corresponds to the transmitting circuit 2 in FIG. 18 partially modified so that the differential digital electric input signal is inputted from differential input terminals 1a and 1b. Hereinafter, the two signals constituting the differential digital electric input signal will be referred to as a first differential input signal A and a second differential input signal A′.

The transmitting circuit 2 in FIG. 20 has a NOR circuit 68 that generates a first electric pulse signal D and a NOR circuit 43 that generates a second electric pulse signal G. The NOR circuit 68 performs a NOR operation between an output signal B of a delay circuit 67 that delays the first differential input signal A and the second differential input signal A′(C), in order to generate the first electric pulse signal D. The NOR circuit 43 performs a NOR operation between an output signal F of a delay circuit 69 that delays the second differential input signal A′ and the first differential input signal A(E), in order to generate the second electric pulse signal G.

Both the delay circuits 67 and 69 delay input signals with a signal transmission delay corresponding to four inverter circuits. For this reason, the first and second electric pulse signals have pulse widths equivalent to the signal transmission delay corresponding to the four inverter circuits. Based on these electric pulse signals, the first and second light-emitting elements 3 and 4 generate first and second optical signals, respectively.

In the transmitting circuit 2 in FIG. 20, pulse widths of the first and second electric pulse signals can also be arbitrarily set by changing the number of inverter circuits in the delay circuits 67 and 69. Furthermore, in FIG. 20, the first and second differential input signals are directly inputted to the delay circuits 67 and 69, and the NOR circuits 43 and 68, but the first and second differential input signals may be received by a differential buffer firstly and the outputs of the differential buffer may be supplied to the delay circuits 67 and 69, and the NOR circuits 43 and 68 as the first differential input signal A and the second differential input signal A′.

The above described various internal configurations of the transmitting circuit 2 can be combined according to need as appropriate. For example, the transmitting circuit 2 in FIG. 20 may be provided with the bias resistance element and the variable resistance element shown in FIG. 13 and FIG. 14 or the like or the variable delay circuit shown in FIG. 16. Furthermore, the input in FIG. 20 may be a single end signal input and the digital electric input signal may be converted to a differential signal by a differential amplifier.

### Fifth Embodiment

In the above described first to fourth embodiments, the transmitting circuit 2 separately generates a first electric pulse signal synchronized with the rising edge and a second electric pulse signal synchronized with the falling edge. However, one signal synchronized with both edges may be generated firstly and then separated into first and second electric pulse signals.

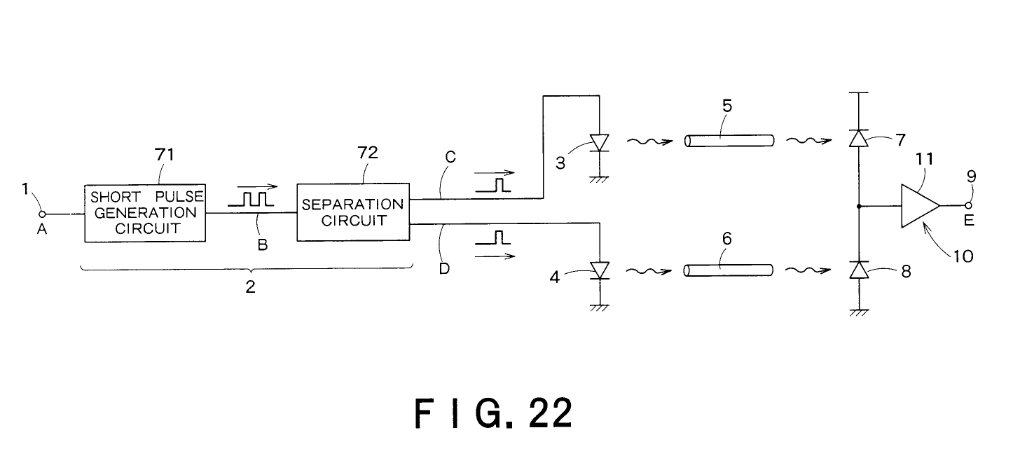

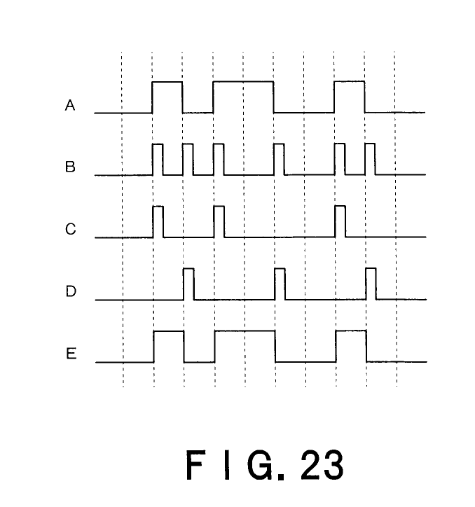

FIG. 22 is a block diagram showing a schematic configuration of a complementary optical wiring system according to a fifth embodiment of the present invention, and FIG. 23 is timing charts of nodes A to E in FIG. 22. The system in FIG. 22 has features, one of which is in the configuration of the transmitting circuit 2. The transmitting circuit 2 in FIG. 22 includes a short pulse generation circuit 71 and a separation circuit 72. As shown in a waveform B in FIG. 23, this short pulse generation circuit 71 generates a short pulse signal including a pulse synchronized with the rising edge and a pulse synchronized with the falling edge of a digital electric input signal. The individual short pulses have a pulse width narrower than a minimum pulse width of the digital electric input signal.

The separation circuit 72 separates the short pulse signal into a first electric pulse signal C synchronized with the rising edge and a second electric pulse signal D synchronized with the falling edge. The first electric pulse signal C is supplied to a first light-emitting element 3, and the second electric pulse signal D is supplied to a second light-emitting element 4.

An optical short pulse (first optical signal) generated by the first light-emitting element 3 is transmitted via a first optical transmission path 5, and an optical short pulse (second optical signal) generated by the second light-emitting element 4 is transmitted via a second optical transmission path 6.

A first light-receiving element 7 receives the first optical signal and converts the signal to a third electric pulse signal. A second light-receiving element 8 receives the second optical signal and converts the signal to a fourth electric pulse signal. An input end of an amplification circuit 11 in a receiving circuit 10 is charged/discharged by the third and fourth electric pulse signals. The amplification circuit 11 amplifies the voltage at the input end and generates a digital electric output signal.

In this way, according to the fifth embodiment, since a short pulse signal including rising edge and falling edge information of a digital electric input signal is generated firstly and then the short pulse signal is separated to generate first and second electric pulse signals. Therefore, similarly to the case of the above described first to fourth embodiments, optical power can be reduced, and there are no problems of shortage of light-emitting current, pattern effect, occurrence of excessive pulses or the like.

### Sixth Embodiment

A sixth embodiment relates to specific example of the transmitting circuit 2 of the fifth embodiment.

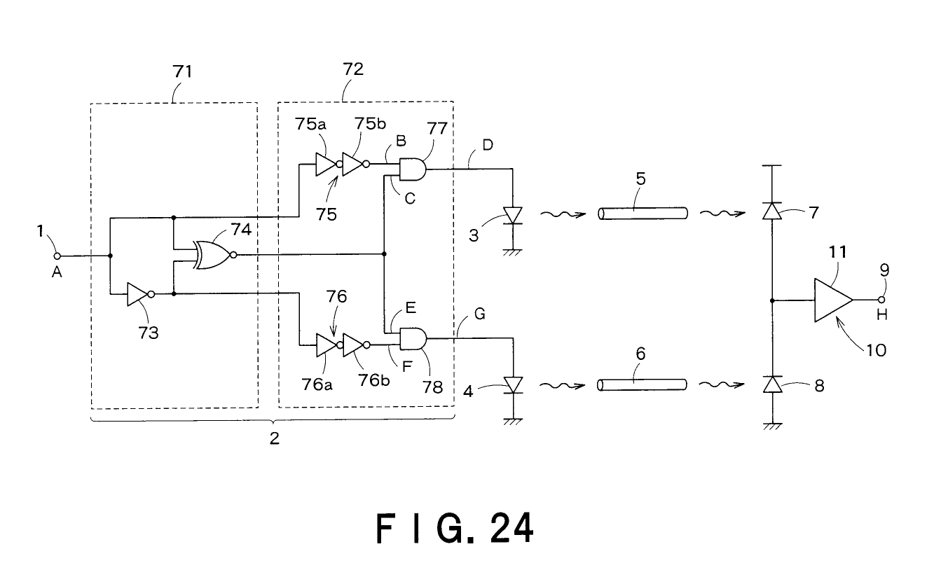

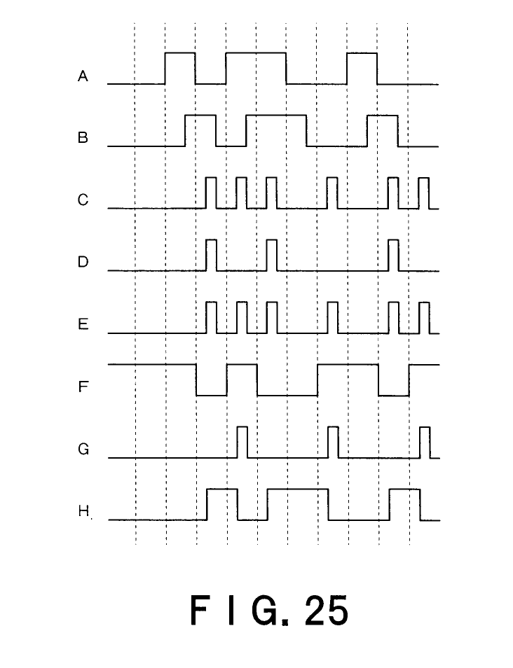

FIG. 24 is a circuit diagram showing a schematic configuration of a complementary optical wiring system according to the sixth embodiment of the present invention, and FIG. 25 is timing charts of nodes A to H in FIG. 24.

The short pulse generation circuit 71 in FIG. 24 includes an inverter circuit 73 that inverts and delays a digital electric input signal, and an XNOR circuit 74 that inverts the result of an exclusive OR operation between the digital electric input signal and the delayed signal from the inverter circuit 73.

The separation circuit 72 in FIG. 24 includes a delay circuit 75 that delays the digital electric input signal, a delay circuit 76 that delays the output signal of the inverter circuit 73, an AND circuit 77 that performs an AND operation between an output signal B of the delay circuit 75 and an output signal C of the XNOR circuit 74 to separate a first electric pulse signal, and an AND circuit 78 that performs an AND operation between an output signal F of the delay circuit 76 and an output signal E of the XNOR circuit 74 to separate a second electric pulse signal.

As shown in FIG. 25, the XNOR circuit 74 generates a delayed signal resulting from delaying the digital electric input signal and a short pulse signal C(E) including a pulse synchronized with the rising edge and a pulse synchronized with the falling edge of the digital electric input signal from the digital electric input signal.

The signal transmission delay time of the XNOR circuit 74 is very large and is, for example, on the order of four times the signal transmission delay time of inverter circuits 75a, 75b, 76a or 76b. Therefore, the delay circuits 75 and 76 are provided so as to delay the digital electric input signal and the delayed signal thereof to the same extent as the short pulse signal. Therefore, the AND circuit 77 extracts only the pulse synchronized with the rising edge included in the short pulse signal as a first electric pulse signal D. Furthermore, the AND circuit 78 only the pulse synchronized with the falling edge included in the short pulse signal as a second electric pulse signal G. FIG. 25 shows timing charts in which the signal transmission delays of the above described XNOR circuit and inverter circuit are taken into consideration.

The number of inverter circuits connected in the delay circuits 75 and 76 is preferably adjusted according to the actual signal transmission delay time of the XNOR circuit 74.

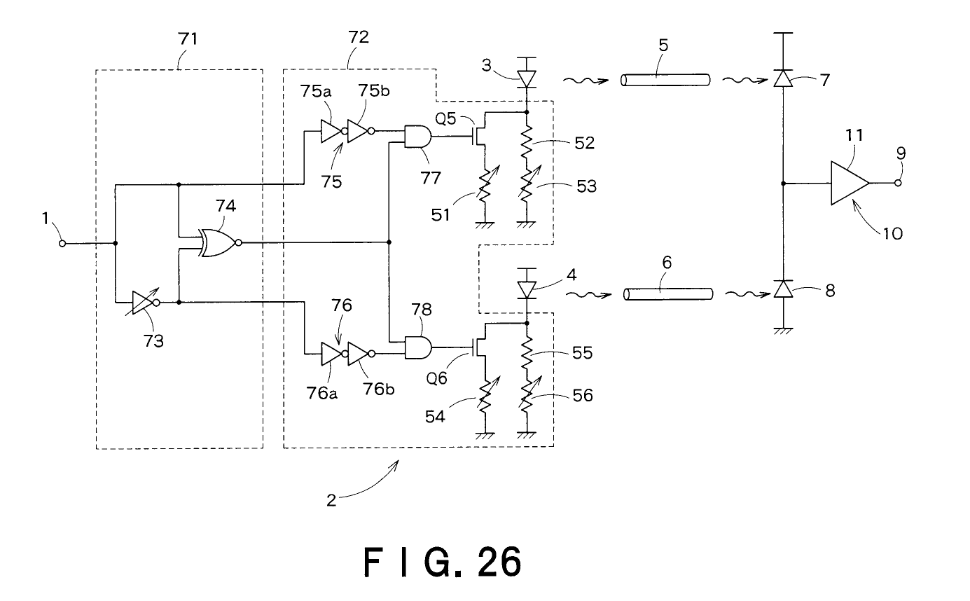

It is possible to control the amount of bias current and the amount of light-emitting current by adding a resistance element similar to that shown in FIG. 14 to the transmitting circuit 2 in FIG. 24. FIG. 26 is a circuit diagram showing a modification example of FIG. 24. The transmitting circuit 2 in FIG. 26 includes, as in the case of FIG. 14, a variable resistance element 51 connected between the source of an NMOS transistor Q5 and a grounding terminal, a resistance element 52 and a variable resistance element 53 connected in series between the drain of the NMOS transistor Q5 and a grounding terminal, a variable resistance element 54 connected between the source of an NMOS transistor Q6 and a grounding terminal, and a resistance element 55 and a variable resistance element 56 connected in series between the drain of the NMOS transistor Q6 and a grounding terminal.

Furthermore, in FIG. 26, a variable delay circuit 73 is provided in a short pulse generation circuit 71, but the variable delay circuit 73 may be replaced by the normal inverter circuit 73 shown in FIG. 24.

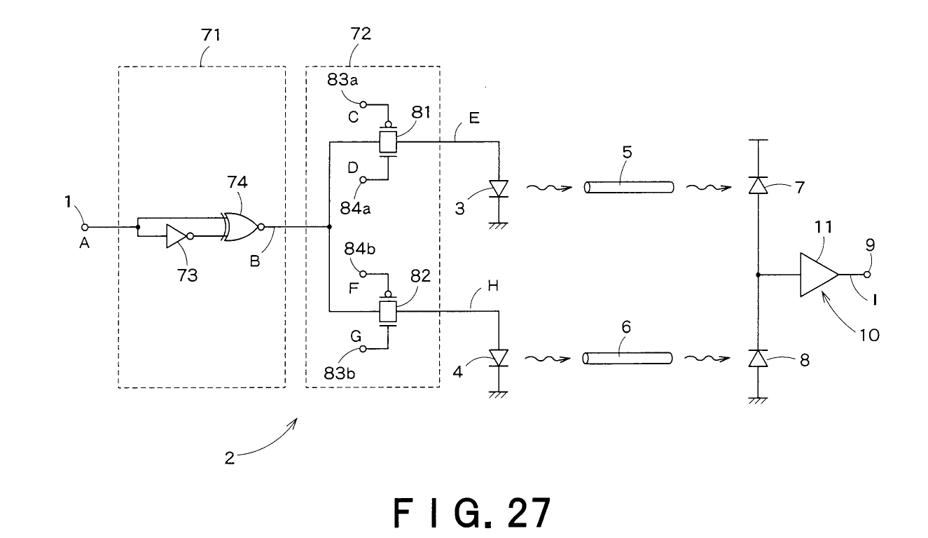

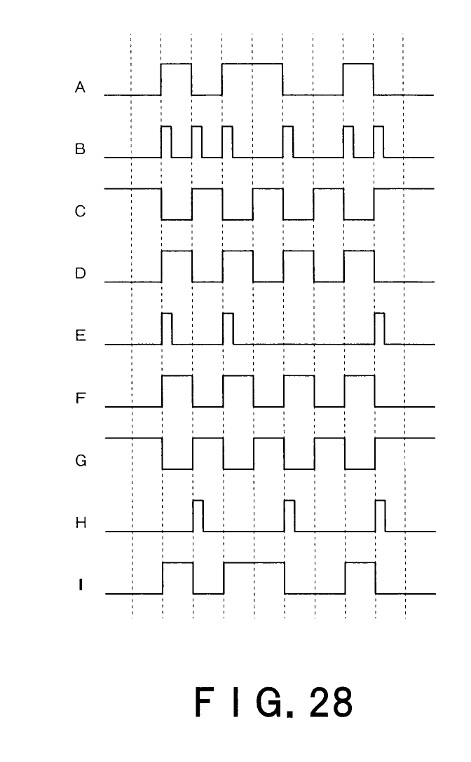

In addition, the internal configurations of the short pulse generation circuit 71 and separation circuit 72 can be modified in various ways without departing from the essence of the present invention. For example, FIG. 27 is a circuit diagram showing a modification example provided with a separation circuit 72 having a circuit configuration different from that in FIG. 24, and FIG. 28 is timing charts of nodes A to I in FIG. 27. The separation circuit 72 in FIG. 27 includes a first complementary pass gate 81 that separates a first electric pulse signal and a second complementary pass gate 82 that separates a second electric pulse signal.

The first and second complementary pass gates 81 and 82 include an NMOS transistor and a PMOS transistor, input/output terminals of which are connected together. Half clock input terminals 83a and 83b with negative logic are connected to the gate of the PMOS transistor in the first complementary pass gate 81 and the gate of the NMOS transistor in the second complementary pass gate 82. Half clock input terminals 84a and 84b with positive logic are connected to the gate of the NMOS transistor in the first complementary pass gate 81 and the gate of the PMOS transistor in the second complementary pass gate 82. Here, the half clock is a clock having a period equivalent to twice the minimum bit width of the digital electric input signal as shown in waveforms C, D, F and G in FIG. 28.

FIG. 28 shows the respective signal waveforms ignoring the signal transmission delays in an XNOR circuit 74 for simplicity. Both the NMOS transistor and PMOS transistor in the first complementary pass gate 81 turn ON when the half clock C of negative logic is low and the half clock D of positive logic is high, and transmit an output signal B of the XNOR circuit 74. At timing at which the first complementary pass gate 81 turns ON, the output signal B of the XNOR circuit 74 includes only pulses synchronized with the rising edges of the digital electric input signal A. Therefore, the first complementary pass gate 81 can separate pulses synchronized with the rising edges of the digital electric input signal A, and a first electric pulse signal E is generated.

Both the NMOS transistor and the PMOS transistor in the second complementary pass gate 82 turn ON when the half clock F of positive logic is low and the half clock G of negative logic is high, and transmit the output signal B of the XNOR circuit 74. At timing at which the second complementary pass gate 82 turns ON, the output signal B of the XNOR circuit 74 includes only pulses synchronized with the falling edges of the digital electric input signal A. Therefore, the second complementary pass gate 82 can separate pulses synchronized with the falling edges of the digital electric input signal A, and a second electric pulse signal H is generated.

In this way, according to the sixth embodiment, although half clocks need to be provided separately, the rising edge information and falling edge information can simply and reliably separated from a short pulse signal including rising edge information and falling edge information, and the first and second electric pulse signals can be generated.

### Seventh Embodiment

A seventh embodiment is designed to make it possible to transmit, through one signal, a pulse synchronized with the rising edge and a pulse synchronized with the falling edge of a digital electric input signal and distinguish both pulses.

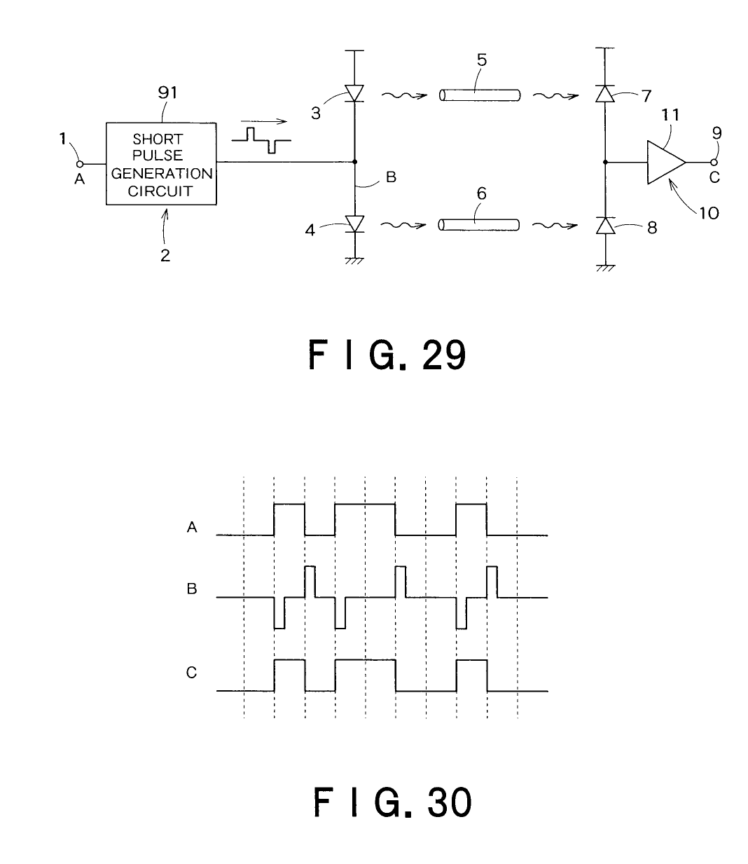

FIG. 29 is a block diagram showing a schematic configuration of a complementary optical wiring system according to the seventh embodiment of the present invention, and FIG. 30 is timing charts of nodes A to C in FIG. 29. The transmitting circuit 2 in FIG. 29 is provided with a short pulse generation circuit 91 that can generate an electric pulse signal including short pulses of opposite polarity. This short pulse generation circuit 91 generates short pulses B of mutually opposite polarities at the rising edges and the falling edges of a digital electric input signal A. In the example of FIG. 30, the short pulse generation circuit 91 generates short pulses of negative polarity in synchronization with the rising edges and generates short pulses of positive polarity in synchronization with the falling edges of the digital electric input signal.

In this way, the electric pulse signal generated by the short pulse generation circuit 91 is a combination of short pulse (first electric pulse signal) synchronized with the rising edges of the digital electric input signal and short pulse (second electric pulse signal) synchronized with the falling edges made to have polarities opposite to each other.

The electric pulse signal generated in the short pulse generation circuit 91 is supplied to a connection path between the cathode of the first light-emitting element 3 and the anode of the second light-emitting element 4. When a short pulse of negative polarity is included in the electric pulse signal, the voltage on this connection path decreases, the voltage between the anode and cathode of the first light-emitting element 3 increases and an optical short pulse (first optical signal) synchronized with the rising edge is generated by the first light-emitting element 3. When a short pulse of positive polarity is included in the electric pulse signal, the voltage at this connection node increases, the voltage between the anode and cathode of the second light-emitting element 4 increases, and an optical short pulse (second optical signal) synchronized with the falling edge is generated by the second light-emitting element 4.

These two optical short pulses propagate through the first and second optical transmission paths 5 and 6, respectively and are received by the first and second light-receiving elements 7 and 8. The first light-receiving element 7 generates a third electric pulse signal synchronized with the rising edge of the digital electric input signal, and the second light-receiving element 8 generates a fourth electric pulse signal synchronized with the falling edge of the digital electric input signal. The voltage at an input end of an amplification circuit 11 changes according to these third and fourth electric pulse signals, is amplified by the amplification circuit 11 and a digital electric output signal is thereby generated.

The short pulse generation circuit 91 in FIG. 29 generates an electric pulse signal including short pulses of opposite polarity based on the digital electric input signal and a delayed signal resulting from delaying the digital electric input signal by a time shorter than a minimum pulse width thereof. Since the electric pulse signal generated in this way is not a signal generated by a CR differential circuit, the above described problems such as shortage of light-emitting current, pattern effect and the excessive pulses or the like do not occur. Furthermore, optical power can be reduced since the voltage can be set so that only edge information of the digital electric input signal is transmitted and the first and second light-emitting elements 3 and 4 do not emit light during non-pulse transmission such as between contiguous pulses.

In the system in FIG. 29, since the light-emitting elements 3 and 4 are connected in series, the bias voltage is twice that of the first to sixth embodiments, but the system can be constructed in a relatively simple configuration such that the number of wirings between the transmitting circuit 2 and first and second light-emitting elements 3 and 4 can be reduced and so on.

### Eighth Embodiment

An eighth embodiment shows a specific example of the internal configuration of the short pulse generation circuit 91 of the seventh embodiment.

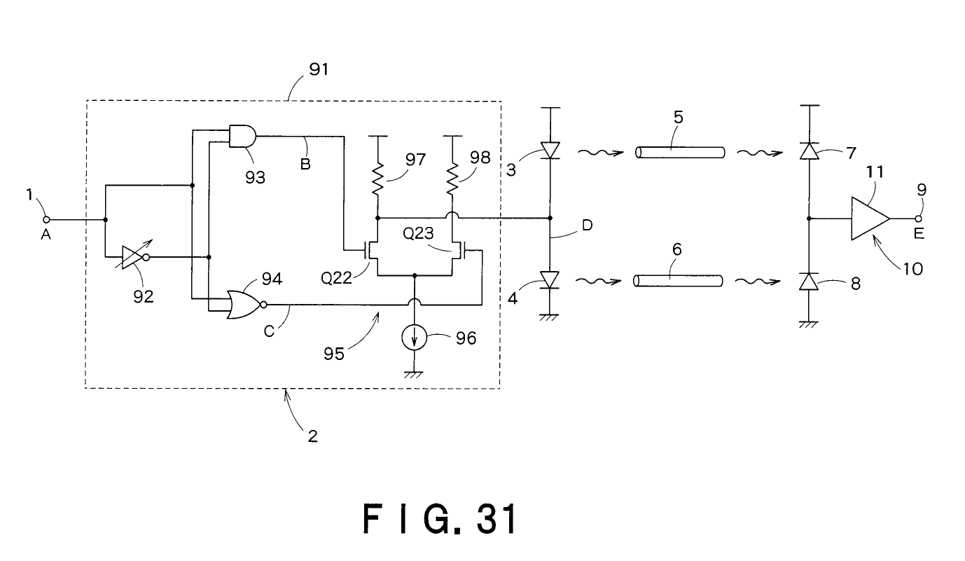

FIG. 31 is a circuit diagram of a complementary optical wiring system according to the eighth embodiment of the present invention, and FIG. 32 is timing charts of nodes A to E in FIG. 31.

The short pulse generation circuit 91 in FIG. 31 includes a variable delay circuit 92, an AND circuit 93, a NOR circuit 94, a differential amplification circuit 95.

The variable delay circuit 92 inverts and delays a digital electric input signal. The AND circuit 93 generates a first electric pulse signal synchronized with the rising edge of the digital electric input signal. The NOR circuit 94 generates a second electric pulse signal synchronized with the falling edge of the digital electric input signal. The a differential amplification circuit 95 combines the first and second electric pulse signals to generate an electric pulse signal including pulses of opposite polarities.

The differential amplification circuit 95 includes a pair of NMOS transistors Q22 and Q23, a current source 96 connected to the sources of the pair of NMOS transistors Q22 and Q23 and resistance elements 97 and 98 connected to the drains of the pair of NMOS transistors Q22 and Q23. An electric pulse signal that combines the first and second electric pulse signals by opposite polarities is outputted from the drain of the NMOS transistor Q22 included in the pair.

When the voltage of a first electric pulse signal B outputted from the AND circuit 93 is higher than that of a second electric pulse signal C outputted from the NOR circuit 94, the resistance of the NMOS transistor Q22 in the differential amplification circuit 95 becomes lower than that of the NMOS transistor Q23, and a large current passes therethrough, leading the drain voltage to drop. In this case, a short pulse of negative polarity is generated. When the voltage of the second electric pulse signal C outputted from the NOR circuit 94, is higher than that of the first electric pulse signal B outputted from the AND circuit 93, the resistance of the NMOS transistor Q23 becomes lower than that of the NMOS transistor Q22 and a large current flows therethrough. In this case, the current that flows through the NMOS transistor Q22 in a pair relationship decreases and the drain voltage thereof increases. In this case, a short pulse of positive polarity is generated. When both the AND circuit 93 and NOR circuit 94 are low, currents of the same level flow through the NMOS transistor Q22 and the NMOS transistor Q23 and the drain terminal of the NMOS transistor Q22 has a potential intermediate between the potentials of the short pulses of positive polarity and negative polarity.

The first electric pulse signal generated by the AND circuit 93 and the second electric pulse signal generated by the NOR circuit 94 have a pulse width corresponding to the delay time of the variable delay circuit 92, respectively. This pulse width can be arbitrarily modified by adjusting the amount of delay of the variable delay circuit 92. An inverter circuit may be used instead of the variable delay circuit 92 to provide a fixed delay.

In this way, the differential amplification circuit 95 generates an electric pulse signal D including a short pulse of negative polarity when the first electric pulse signal is high and a short pulse of positive polarity when the second electric pulse signal is high, respectively.

The electric pulse signal D is supplied to the connection node of the first and second light-emitting elements 3 and 4, and first and second optical signals are generated. These optical signals propagate through the first and second optical transmission paths 5 and 6 and are received by the first and second light-receiving elements 7 and 8. The first and second light-receiving elements 7 and 8 generate third and fourth electric pulse signals and the amplification circuit 11 generates a digital electric output signal E based on these electric pulse signals.

In this way, according to the eighth embodiment, an electric pulse signal including short pulses of opposite polarities can be easily generated using the differential amplification circuit 95.

### Ninth Embodiment

In the above described first to eighth embodiments, first and second electric pulse signals are generated using one type of short pulse generation circuit 91. On the other hand, in a ninth embodiment a first electric pulse signal and a second electric pulse signal are generated using different circuits, respectively.

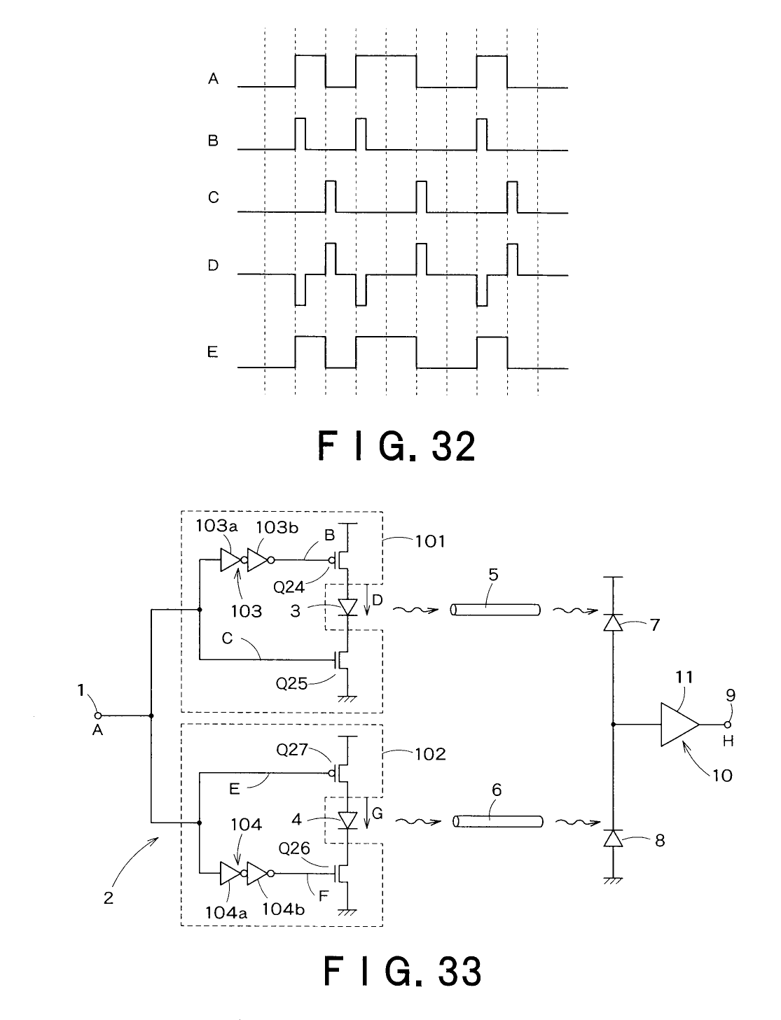

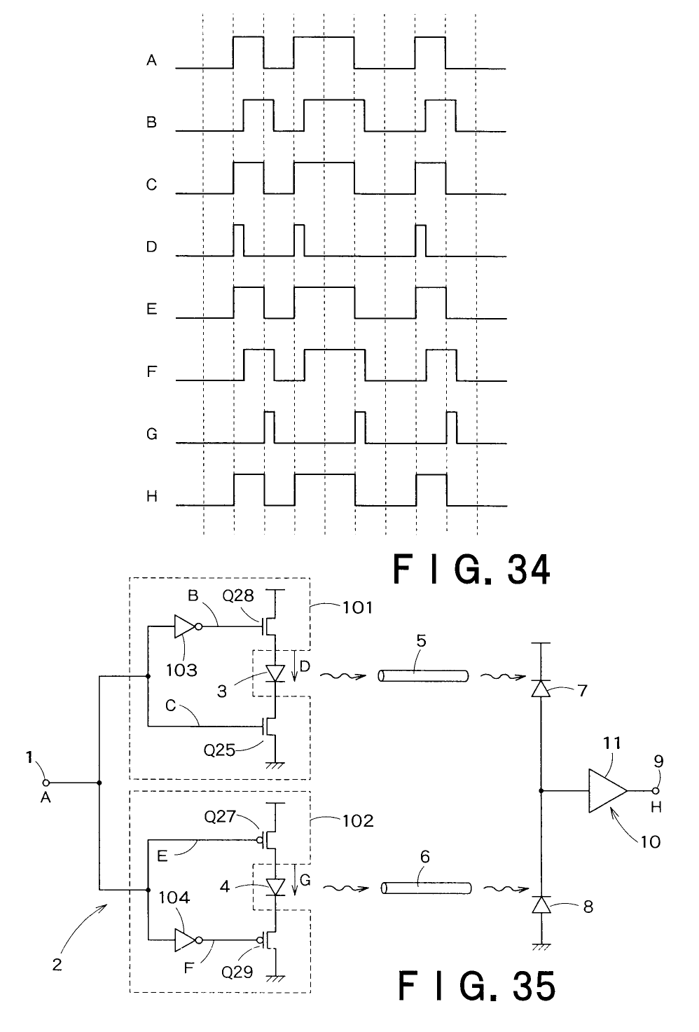

FIG. 33 is a circuit diagram showing a schematic configuration of a complementary optical wiring system according to a ninth embodiment of the present invention. FIG. 34 is timing charts of nodes A to H in FIG. 33.

The transmitting circuit 2 in FIG. 33 includes a first transmitter 101 and second transmitter 102. The first transmitter 101 combines a first delayed signal resulting from delaying a digital electric input signal by a time shorter than a minimum pulse width of the digital electric input signal with the digital electric input signal, thereby generating a first electric pulse signal at timing synchronized with the rising edge of the digital electric input signal. The second transmitter 102 combines a second delayed signal resulting from delaying the digital electric input signal by a time shorter than a minimum pulse width of the digital electric input signal with the digital electric input signal, thereby generating a second electric pulse signal at timing synchronized with the falling edge of the digital electric input signal.

The first transmitter 101 includes a delay circuit 103 that generates a first delayed signal B by delaying a digital electric input signal A, a PMOS transistor Q24, to the gate of which the first delayed signal B is inputted and an NMOS transistor Q25, to the gate of which the digital electric input signal A(C) is directly inputted. The source of the PMOS transistor Q24 is connected to a power supply terminal and the drain thereof is connected to the anode of the first light-emitting element 3. The drain of the NMOS transistor Q25 is connected to the cathode of the first light-emitting element 3 and the source thereof is grounded.

The second transmitter 102 includes a delay circuit 104 that generates a second delayed signal F by delaying the digital electric input signal A, an NMOS transistor Q26, to the gate of which the second delayed signal F is inputted and a PMOS transistor Q27, to the gate of which the digital electric input signal A(E) is directly inputted. The source of the PMOS transistor Q27 is connected to a power supply terminal and the drain is connected to the anode of the second light-emitting element 4. The drain of the NMOS transistor Q26 is connected to the cathode of the second light-emitting element 4 and the source is grounded.

When the digital electric input signal A changes from low to high, the NMOS transistor Q25 in the first transmitter 101 immediately turns ON, but the PMOS transistor Q24 turns ON from OFF with a small delay due to the presence of the delay circuit 103. For this reason, immediately after the digital electric input signal A changes from low to high, both the NMOS transistor Q25 and the PMOS transistor Q24 in the first transmitter 101 turn ON during a time corresponding to a signal transmission delay time of the delay circuit 103. Therefore, a current (first electric pulse signal) D flows through the first light-emitting element 3 and an optical short pulse (first optical signal) is outputted.

Likewise, when the digital electric input signal A changes from high to low, the PMOS transistor Q27 in the second transmitter 102 immediately turns ON, but the NMOS transistor Q26 turns ON with a small delay due to the presence of the delay circuit 104. Therefore, immediately after the digital electric input signal A changes from high to low, both the NMOS transistor Q26 and the PMOS transistor Q27 in the second transmitter 102 turn ON during a time corresponding to a signal transmission delay time of the delay circuit 104. Therefore, a current (second electric pulse signal) G flows through the second light-emitting element 4 and an optical short pulse (second optical signal) is outputted.

The first and second optical signals propagate through the first and second optical transmission paths 5 and 6, respectively and are received by the first and second light-receiving elements 7 and 8. The first and second light-receiving elements 7 and 8 generate third and fourth electric pulse signals and the voltage at the input end of the amplification circuit 11 changes according to these signals. The amplification circuit 11 amplifies this voltage to generate a digital electric output signal H.

In this way, in the system of FIG. 33, the first transmitter 101 generates a first electric pulse signal and the second transmitter 102 generates a second electric pulse signal. Since the circuit configuration of the first transmitter 101 is substantially the same as the circuit configuration of the second transmitter 102, the embodiment provides a feature of achieving a high level of symmetry and producing less circuit jitter.

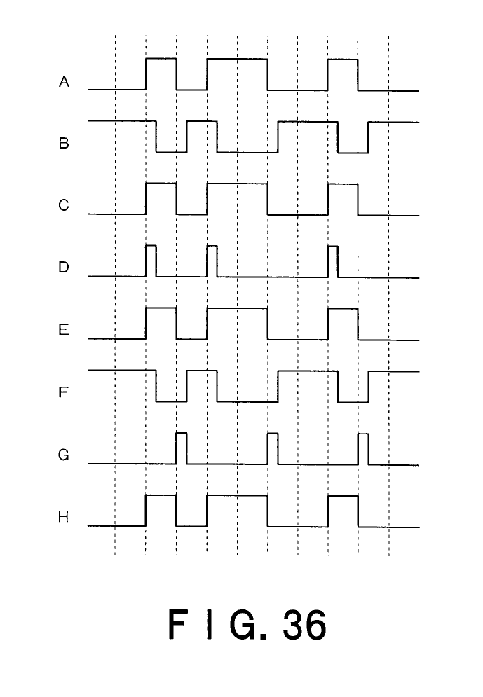

The internal configurations of the first and second transmitters 101 and 102 are not limited to those shown in FIG. 33. FIG. 35 is a circuit diagram showing a modification example of FIG. 33, and FIG. 36 is timing charts of nodes A to H in FIG. 35. The first transmitter 101 of FIG. 35 includes a delay circuit 103 that generates a first delayed signal by delaying a digital electric input signal, an NMOS transistor Q28, to the gate of which the first delayed signal is inputted and an NMOS transistor Q25, to the gate of which the digital electric input signal is directly inputted. The second transmitter 102 includes a delay circuit 104 that generates a second delayed signal by delaying the digital electric input signal, a PMOS transistor Q27, to the gate of which the digital electric input signal is directly inputted and an NMOS transistor Q29, to the gate of which the second delayed signal is inputted.

In FIG. 35, the number of inverter circuits constituting the delay circuits 103 and 104 is different from that of FIG. 33 and the output follows the inverted logic of the input. Therefore, the conductivity type of the transistors Q28 and Q29 at subsequent side of the delay circuits 103 and 104 is opposite to that of FIG. 33.

As shown in FIG. 36, when the digital electric input signal A(C) changes from low to high, an output B of the delay circuit 103 changes from high to low with a delay corresponding to a signal transmission delay time. Therefore, both the NMOS transistors Q28 and Q25 turn ON during the time corresponding to the signal transmission delay time of the delay circuit 103 and a first electric pulse signal D is generated. In this way, the first light-emitting element 3 generates an optical short pulse (first optical signal).

Furthermore, when the digital electric input signal A(E) changes from high to low, an output F of the delay circuit 104 changes from low to high with a delay corresponding to a signal transmission delay time. Therefore, both the PMOS transistor Q27 and Q29 turn ON during the time corresponding to the signal transmission time of the delay circuit 104 and a second electric pulse signal G is generated. In this way, the second light-emitting element 4 generates an optical short pulse (second optical signal).

The first and second optical signals propagate through the first and second optical transmission paths 5 and 6 and are received by the first and second light-receiving elements 7 and 8. The first and second light-receiving elements 7 and 8 generate third and fourth electric pulse signals and the voltage at an input end of the amplification circuit 11 changes according to these signals. The amplification circuit 11 amplifies this voltage and generates a digital electric output signal H.

The first and second transmitters 101 and 102 in FIG. 33 and FIG. 35 may be arbitrarily combined and configured. That is, the internal configuration of the first transmitter 101 may be any one of the configurations in FIG. 33 and FIG. 35, and the internal configuration of the second transmitter 102 may be any one of the configurations in FIG. 33 and FIG. 35. Furthermore, the number of NMOS transistors and PMOS transistors provided in the first and second transmitters 101 and 102 and connection order may be arbitrarily changed. Furthermore, a circuit configuration has been shown here where the first and second light-emitting elements 3 and 4 are interposed between two transistors, but the configuration may also be such that the anode of the light-emitting element is connected to a power supply and two transistors are arranged on the cathode side, or the cathode of the light-emitting element is grounded and two transistors are arranged on the anode side. Furthermore, the connection order can also be arbitrarily changed in the first and second transmitters, respectively.

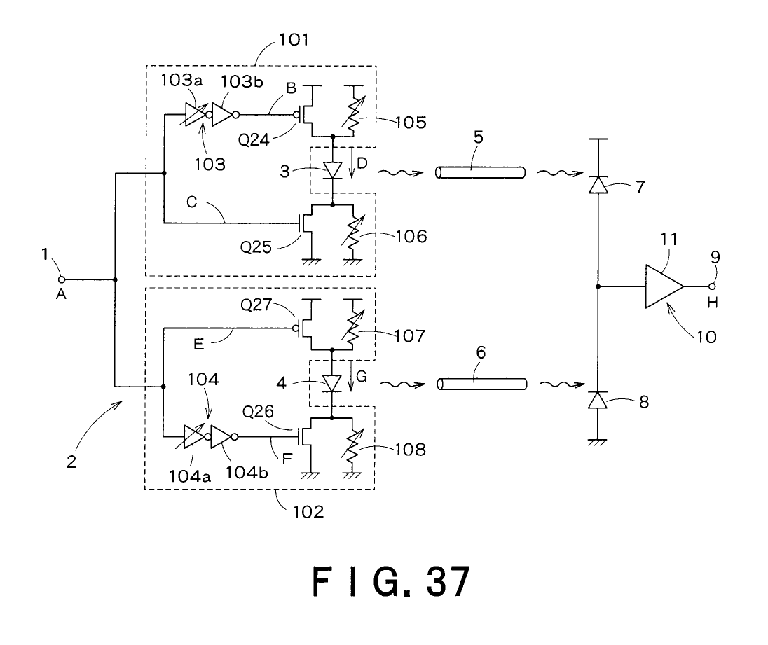

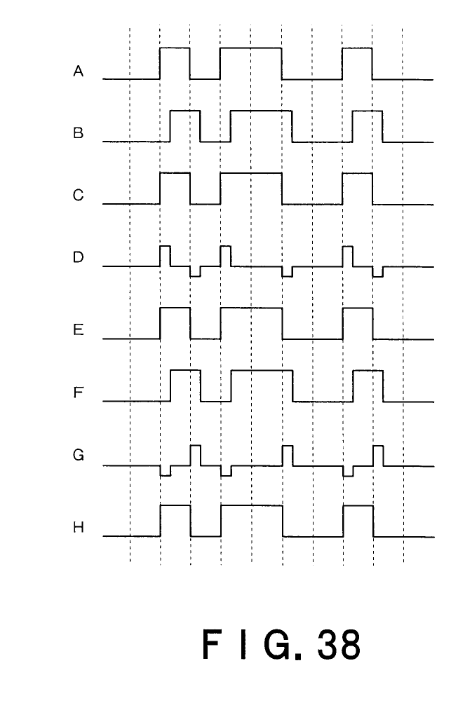

The first and second light-emitting elements 3 and 4 are electrically independent of each other and bias currents can be supplied individually. FIG. 37 is a circuit diagram with resistance elements 105 to 108 to supply bias current added to the circuit in FIG. 33, and FIG. 38 is timing charts of nodes A to H in FIG. 37.

In addition to the configuration in FIG. 33, the first transmitter 101 in FIG. 37 includes a variable resistance element 105 connected between a power supply terminal and the anode of the first light-emitting element 3 in parallel with a PMOS transistor Q24 and the variable resistance element 106 connected between the cathode of the first light-emitting element 3 and a grounding terminal in parallel with an NMOS transistor Q25. In addition to the configuration in FIG. 33, the second transmitter 102 in FIG. 37 includes the variable resistance element 107 connected between a power supply terminal and the anode of the second light-emitting element 4 in parallel with a PMOS transistor Q27 and the variable resistance element 108 between the cathode of the second light-emitting element 4 and a grounding terminal in parallel with an NMOS transistor Q26.

In FIG. 38, when a digital electric input signal A(C) changes from low to high, both the PMOS transistor Q24 and NMOS transistor Q25 turn ON during a time corresponding to a signal transmission delay time of the delay circuit 103 in the first transmitter 101. When only one of these transistors Q24 and Q25 turns ON, a bias current is supplied to the first light-emitting element 3 via the ON-state transistor and the variable resistance elements 105 and 106. This bias current is set to, for example, 100 μA so as to be in the vicinity of an ON-voltage (voltage at which a current starts to flow) of the first light-emitting element 3. This allows the first light-emitting element 3 to operate in a relatively linear differential resistance region above the region where a current starts to flow into the first light-emitting element 3.

When the digital electric input signal changes from high to low, both the PMOS transistor Q27 and the NMOS transistor Q26 turn ON during a time period corresponding to a signal transmission delay time of the delay circuit 104 in the second transmitter 102. When only one of these transistors Q26 and Q27 is ON, a bias current is supplied to the second light-emitting element 4 via the ON-state transistor and the variable resistance elements 107 and 108. This bias current is set to, for example, 100 μA so as to be in the vicinity of an ON-voltage (voltage at which a current starts to flow) of the second light-emitting element 4. This allows the second light-emitting element 4 to operate in a relatively linear differential resistance region above the region where a current starts to flow into the second light-emitting element 4.

When both the PMOS transistor Q24 and NMOS transistor Q25 in the first transmitter 101 is OFF (B is high and C is low in FIG. 38) or both the PMOS transistor Q27 and NMOS transistor Q26 in the second transmitter 102 is OFF (E is high and F is low in FIG. 38), a bias current is supplied to the first or second light-emitting elements 3 and 4 via the variable resistance elements 105 to 108, but the bias current supplied is small compared to the case where one transistor is ON as shown by “D” and “G” in FIG. 38.

Here, any one transistor is always ON immediately before both the PMOS transistor Q24 and NMOS transistor Q25 in the first transmitter 101 and the PMOS transistor Q27 and NMOS transistor Q26 in the second transmitter 102 turn ON, and a bias current is supplied through the variable resistance elements 105 to 108. Therefore, not only there are no problems with the operations of the first and second light-emitting elements 3 and 4, but also it is rather possible to reduce useless bias currents and reduce power consumption.

### Tenth Embodiment

In a tenth embodiment, first and second electric pulse signals are generated using a logic transition of the frequency-divided signal, which is a divided signal of a digital electric input signal.

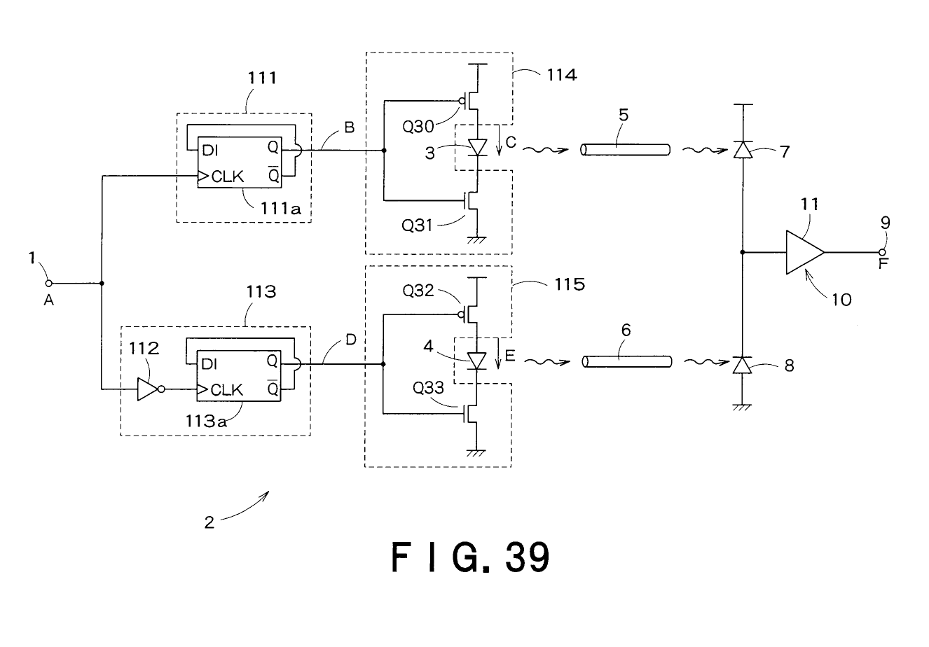

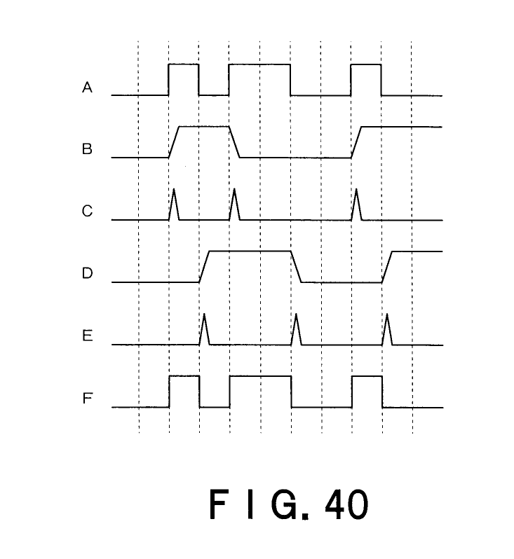

FIG. 39 is a circuit diagram of a complementary optical wiring system according to the tenth embodiment of the present invention, and FIG. 40 is timing charts of nodes A to F in FIG. 39. The system in FIG. 39 has a configuration of the transmitting circuit 2 different from that of the above described embodiments, but the receiving side has the same configuration.

The transmitting circuit 2 in FIG. 39 includes a first frequency division circuit 111, a second frequency division circuit 113, a first electric pulse signal generation circuit 114 and a second electric pulse signal generation circuit 115.

The second frequency division circuit 113 generates a first frequency-divided signal whose logic is inverted in synchronization with the rising edge of a digital electric input signal. The second frequency division circuit 113 generates a second frequency-divided signal whose logic is inverted in synchronization with the falling edge of the digital electric input signal. The first electric pulse signal generation circuit 114 generates a first electric pulse signal at timing synchronized with a logical transition of the first frequency-divided signal. The second electric pulse signal generation circuit 115 generates a second electric pulse signal at timing synchronized with a logical transition of the second frequency-divided signal.

The first and second frequency division circuits 111 and 113 have D flip flops 111a and 113a. The second frequency division circuit 113 includes an inverter circuit 112 at the input thereof. The D flip flops 111a and 113a short-circuit between a /Q terminal and a DI terminal and output a signal frequency-divided by 2 from a Q terminal.

As shown in FIG. 40, an output signal B of the first frequency division circuit 111 is a signal inverted at the rising edge of a digital electric input signal A.

The first electric pulse signal generation circuit 114 includes a PMOS transistor Q30, to the gate of which the signal B is inputted and an NMOS transistor Q31, to the gate of which the signal B is inputted. The source of the PMOS transistor Q30 is connected to a power supply terminal, the drain thereof is connected to the anode of the first light-emitting element 3, the drain of the NMOS transistor Q31 is connected to the cathode of the first light-emitting element 3 and the source thereof is grounded.

When the output signal B of the first frequency division circuit 111 changes from low to high, and from high to low, the PMOS transistor Q30 and the NMOS transistor Q31 momentarily turn ON simultaneously and a through current (first electric pulse signal) C flows between both transistors Q30 and Q31. This through current causes the first light-emitting element 3 to generate an optical short pulse (first optical signal).

An output signal D of the second frequency division circuit 113 is a signal that is inverted at the rising edge of a signal resulting from inverting the digital electric input signal A, that is, at the falling edge of the digital electric input signal A.

The second electric pulse signal generation circuit 115 includes a PMOS transistor Q32, to the gate of which the signal D is inputted, and an NMOS transistor Q33, to the gate of which the signal D is inputted. The source of the PMOS transistor Q32 is connected to a power supply terminal and the drain thereof is connected to the anode of the second light-emitting element 4, and the drain of the NMOS transistor Q33 is connected to the cathode of the second light-emitting element 4 and the source thereof is grounded.

When the output signal D of the second frequency division circuit 113 changes from low to high, and from high to low, the PMOS transistor Q32 and the NMOS transistor Q33 momentarily turn ON simultaneously and a through current (second electric pulse signal) E flows between both transistors. This through current causes the second light-emitting element 4 to generate an optical short pulse (second optical signal).

The above described through current is a current treated as a leakage current in the CMOS circuit. However, further low power consumption of the circuit is achieved by actively using the through current here. The intensity of the through current is increased by adding load capacitances to the input parts of the first and second electric pulse signal generation circuits 114 and 115 to slow down the voltage changing of the signal, whereas the intensity of the through current is decreased by reducing the load capacitances and largely changing the voltage.

In this way, according to the tenth embodiment, the first and second frequency division circuits 111 and 113 separate the rising edge information from the falling edge information of the digital electric input signal, and generate first and second optical signals using through currents flowing at the edge at which the frequency-divided signals logically change. Therefore, it is possible to reduce optical power and prevent problems such as a shortage of light-emitting current, pattern effect and occurrence of excessive pulses when a CR differential circuit is used.

Since the first and second light-emitting elements 3 and 4 are electrically independent of each other, the first and second light-emitting elements 3 and 4 can individually supply a bias current as in the case of FIG. 37.

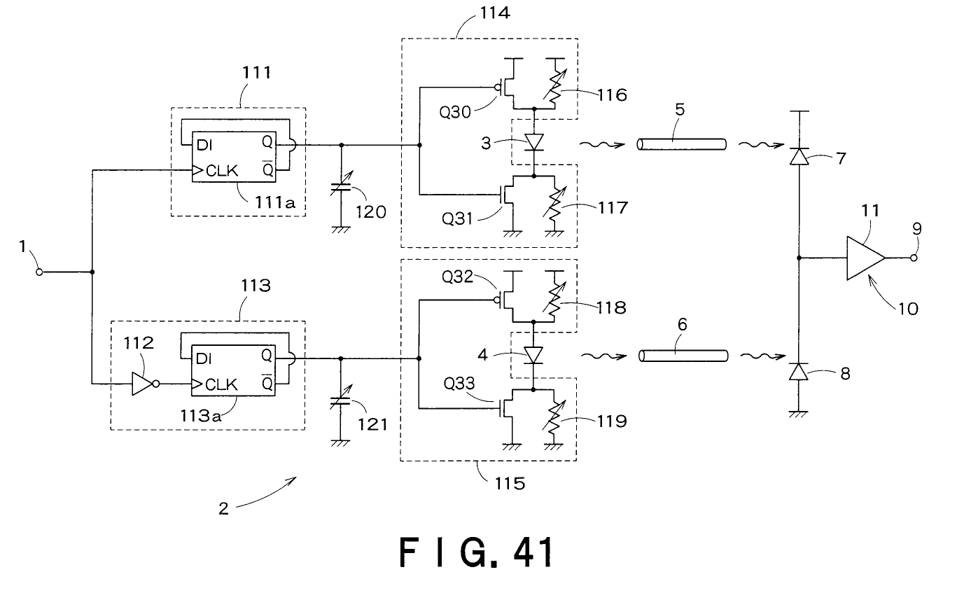

FIG. 41 is a circuit diagram showing a modification example additionally provided with a resistance element to supply a bias current to the circuit in FIG. 39 and further a load capacitance to slow down a voltage changing of an input signal of the electric pulse signal generation circuit.

In addition to the circuit configuration in FIG. 39, the transmitting circuit 2 in FIG. 41 includes a variable resistance element 116 connected between a power supply terminal and the anode of the first light-emitting element 3, a variable resistance element 117 connected between the cathode of the first light-emitting element 3 and a grounding terminal, a variable resistance element 118 connected between a power supply terminal and the anode of the second light-emitting element 4, a variable resistance element 119 connected between the cathode of the second light-emitting element 4 and a grounding terminal, a variable capacitor 120 (first variable capacitor) connected between the input terminal of the first electric pulse signal generation circuit 114 and a grounding terminal, and a variable capacitor 121 (second variable capacitor) connected between the input terminal of the second electric pulse signal generation circuit 115 and a grounding terminal.

When only one of the PMOS transistor Q30 and the NMOS transistor Q31 is ON, a bias current is supplied to the first light-emitting element 3 via the ON-state transistor and the variable resistance elements 116 and 117. Likewise, when only one of the PMOS transistor Q32 and the NMOS transistor Q33 is ON, a bias current is supplied to the second light-emitting element 4 via the ON-state transistor and one of the variable resistance elements 118 and 119.

The variable capacitors 120 and 121 are intended to variably adjust the input load capacitances of the first and second electric pulse signal generation circuits 114 and 115. The transition time of the output signals (input signals of the electric pulse signal generation circuits 114 and 115) of the first and second frequency division circuits 111 and 113 can be controlled by adjusting the capacitances of the variable capacitors 120 and 121. This makes it possible to adjust the through currents flowing through the PMOS transistor Q30 and the NMOS transistor Q31 and the through currents flowing through the PMOS transistor Q32 and the NMOS transistor Q33, thereby controlling the pulse widths (and the amount of light emitted) of the optical short pulses generated by the first and second light-emitting elements 3 and 4.

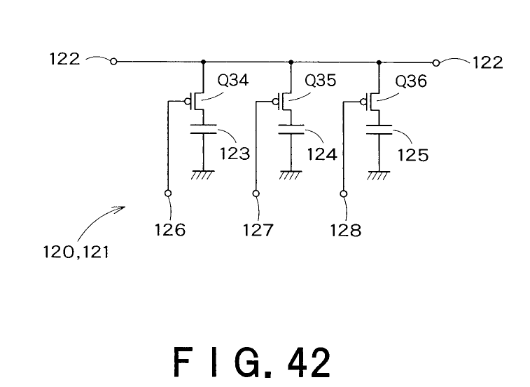

FIG. 42 is a circuit diagram showing an example of an internal configuration of the variable capacitors 120 and 121 in FIG. 41. The variable capacitor in FIG. 42 includes a connection terminal 122 at one end, three PMOS transistors Q34 to Q36, the sources of which are connected to this connection terminal 122, and capacitors 123 to 125 connected between the drains of the PMOS transistors Q34 to Q36 and grounding terminals. Control terminals 126 to 128 are connected to the gates of the PMOS transistors Q34 to Q36, and ON/OFF of the PMOS transistors Q34 to Q36 is individually controlled by control signals inputted to these control terminals 126 to 128. Through control signals, the number of ON-state PMOS transistors Q34 to Q36 can be controlled and capacitances can be thereby adjusted.

Incidentally, examples have been explained in FIG. 39 and FIG. 41 where the D flip flops 111a and 113a are used as specific examples of the first and second frequency division circuits 111 and 113, but this is merely an example and similar functions can be realized in various circuit configurations. Furthermore, there are no particular restrictions on the number and the connection sequence of the PMOS transistors Q30 and Q32 and NMOS transistors Q31 and Q33 that cause through currents to pass through the first and second light-emitting elements 3 and 4. For example, the anode of the first light-emitting element 3 can be connected to the power supply terminal, and the PMOS transistor Q30 and NMOS transistor Q31 can be arranged between the cathode of the first light-emitting element 3 and grounding terminal. Likewise, the anode of the second light-emitting element 4 can be connected to the power supply terminal, and the PMOS transistor Q32 and NMOS transistor Q33 can be arranged between the cathode of the second light-emitting element 4 and grounding terminal.

### Eleventh Embodiment

In an eleventh embodiment, the pulse widths of the first and second electric pulse signals generated by the transmitting circuit 2 are intended to be controlled by feedback from the receiving circuit 10 side.

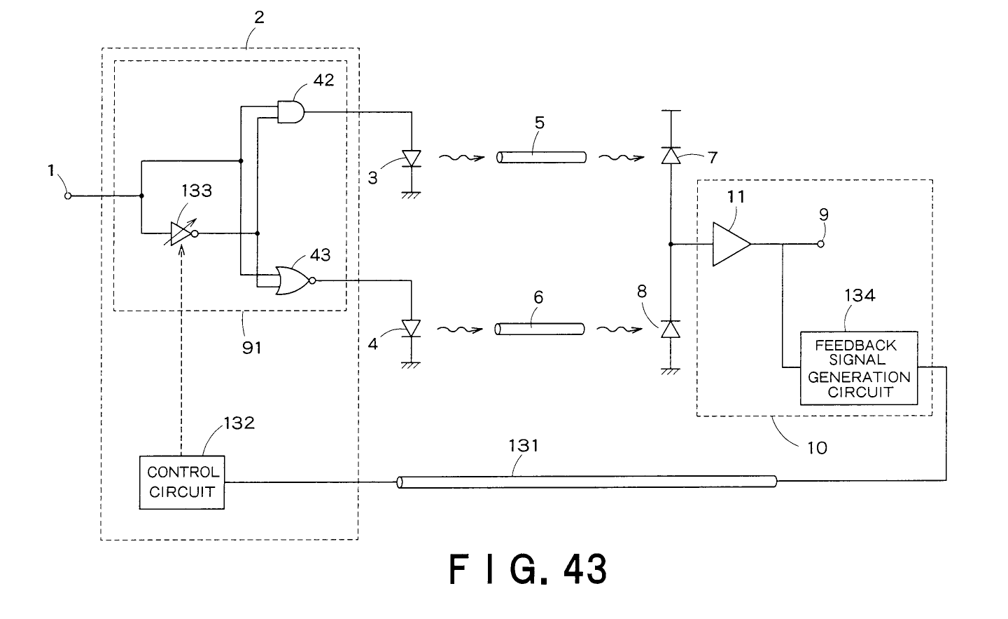

FIG. 43 is a block diagram showing a schematic configuration of a complementary optical wiring system according to an eleventh embodiment of the present invention. In the system in FIG. 43, the configuration of the transmitting circuit 2 and the configuration of the receiving circuit 10 are partially different from those of the system in FIG. 10, and a feedback path 131 is provided between the transmitting circuit 2 and the receiving circuit 10 to transmit a feedback signal generated in the receiving circuit 10 to the transmitting circuit 2.

The transmitting circuit 2 in FIG. 43 includes a control circuit 132 in addition to the short pulse generation circuit 91. The short pulse generation circuit 91 includes a variable delay circuit 133 that inverts and delays a digital electric input signal in addition to the AND circuit 42 and the NOR circuit 43 as in the case of FIG. 10. The control circuit 132 controls the delay time of the variable delay circuit 133 based on the feedback signal transmitted from the receiving circuit 10 via the feedback path 131.

In addition to the amplification circuit 11 as in the case of FIG. 10, the receiving circuit 10 in FIG. 43 includes a feedback signal generation circuit 134 that generates a feedback signal based on signal characteristics of the digital electric output signal generated by the amplification circuit 11.

The feedback signal is transmitted to the transmitting circuit 2 via the feedback path 131, and the signal may be transmitted in an electric signal state or transmitted in an optical signal state. When converted to an optical signal, it is necessary to provide a light-emitting element in the receiving circuit 10 and provide a light-receiving element in the transmitting circuit 2.

The feedback signal generation circuit 134 in the receiving circuit 10 includes a peak detection circuit and a comparator (not shown) inside thereof. The peak detection circuit detects the peak voltage of the digital electric output signal. The comparator compares the peak voltage with a reference voltage and generates, for example, a feedback signal “0” when the peak voltage is equal to or higher than the reference voltage and “1” when less than the reference voltage.

The feedback signal generation circuit 134 can include an amplitude detection circuit and a comparator (not shown) inside thereof. The amplitude detection circuit detects a voltage-amplitude of the digital electric output signal. The comparator compares the voltage-amplitude with a reference voltage and generates, for example, a feedback signal “0” when the voltage-amplitude is equal to or higher than the reference voltage and “1” when less than the reference voltage.

The feedback signal generation circuit 134 can include a jitter detection circuit and a comparator (not shown) inside thereof. The jitter detection circuit detects a voltage proportional to the amount of the jitter in the digital electric output signal. The comparator compares the outputted voltage proportional to the amount of the jitter with a reference voltage and generates, for example, a feedback signal “0” when the voltage proportional to the amount of the jitter is less than the reference voltage and “1” when equal to or higher than the reference voltage.

When the feedback signal is “1,” that is, the peak voltage or the voltage-amplitude of the digital electric output signal is less than the reference voltage, or the voltage proportional to the amount of the jitter is equal to or higher than the reference voltage, the control circuit 132 in the transmitting circuit 2 increases the amount of delay of the variable delay circuit 133. This causes the pulse widths of the first and second electric pulse signals generated by the AND circuit 42 and the NOR circuit 43 to increase and causes the amount of light emitted of the first and second light-emitting elements 3 and 4 to increase. When the amount of light emitted increases, the amount of light received by the first and second light-receiving elements 7 and 8 also increases and the peak voltage or the voltage-amplitude of the digital electric output signal also increase or the voltage proportional to the amount of the jitter decreases. As a result, when the peak voltage or the voltage-amplitude becomes equal to or higher than the reference voltage or the voltage proportional to the amount of the jitter becomes less than the reference voltage, the feedback signal becomes “0.” The control circuit 132 having received this feedback signal reduces the amount of delay of the variable delay circuit 92. This causes the pulse widths of the first and second electric pulse signals to decrease and causes the amount of light emitted of the first and second light-emitting elements 3 and 4 to decrease resulting in a decrease in light-emitting power. By performing the above described feedback control, it is possible to optimize the light-emitting intensity of the first and second optical signals generated by the first and second light-emitting elements 3 and 4.

In this way, according to the eleventh embodiment, since the pulse widths of the first and second electric pulse signals in the transmitting circuit 2 are controlled based on the peak voltage or voltage-amplitude of the digital electric output signal or the amount of the jitter, the digital electric output signal having a desired signal level can be generated.

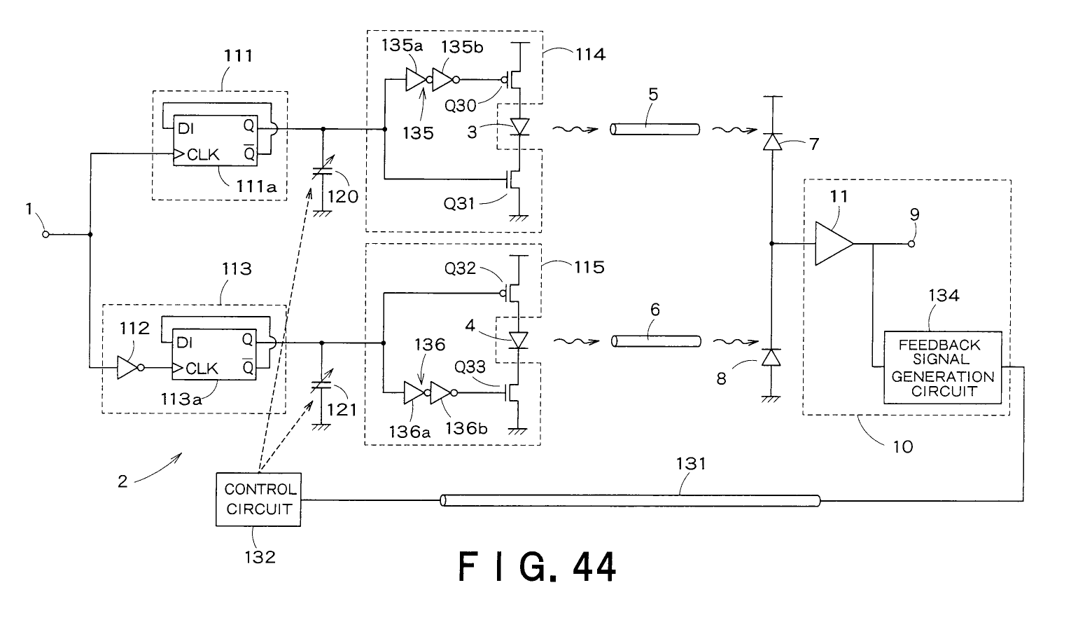

The control circuit 132, feedback path 131 and feedback signal generation circuit 134 shown in FIG. 43 are also applicable to the circuits of the above described various embodiments. For example, FIG. 44 is a block diagram showing a modification example with the control circuit 132, feedback path 131 and feedback signal generation circuit 134 added to the circuit in FIG. 41. In the case of FIG. 44, the control circuit 132 in the transmitting circuit 2 controls capacitances of the variable capacitors 120 and 121 connected to the output terminals of the first and second frequency division circuits 111 and 113 based on a feedback signal from the receiving circuit 10. This makes it possible to control the transition time required for logic inversion of the frequency-divided signals outputted from the first and second frequency division circuits 111 and 113 and variably control the amount of through current. As a result, the amount of optical output of the first and second optical signals generated by the first and second light-emitting elements 3 and 4 are controlled.

The above described control over the amount of optical output can also be realized by variably controlling the resistance values of the variable resistance elements shown in FIG. 26 or FIG. 37 based on a feedback signal and controlling the amount of bias current and the amount of light-emitting current supplied to the first and second light-emitting elements 3 and 4.

An example has been explained above where the feedback signal is a digital signal, but the feedback signal may also be an analog signal whose voltage level continuously changes.

### Other Modification Examples

While various variations of the internal configuration of the transmitting circuit 2 have been mainly explained in the above described embodiments, the internal configuration of the receiving circuit 10 can also be modified as appropriate.

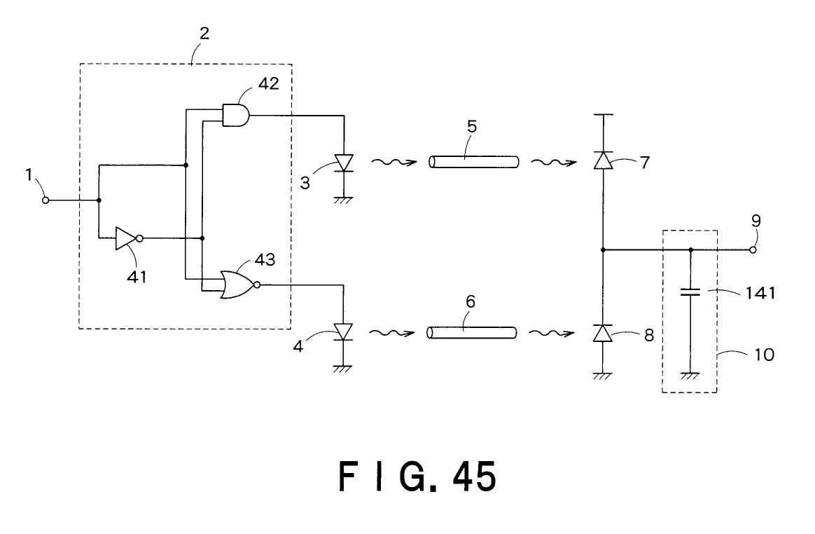

FIG. 45 is a circuit diagram showing a first modification example of the circuit in FIG. 10 and shows an example of the receiving circuit 10 having an internal configuration different from that in FIG. 10. The receiving circuit 10 in FIG. 45 includes a capacitor 141, one end of which is connected to a connection path between the anode of the first light-receiving element 7 and the cathode of the second light-receiving element 8, and the other end of which is grounded.

When the first optical signal transmitted via the first optical transmission path 5 is received by the first light-receiving element 7, the capacitor 141 is charged by the current (third electric pulse signal) flowing through the first light-receiving element 7. When the second optical signal transmitted through the second optical transmission path 6 is received by the second light-receiving element 8, the accumulated charge of the capacitor 141 is discharged by the current (fourth electric pulse signal) that flows through the second light-receiving element 8.

Through such a simple charging/discharging operation, it is possible to generate a digital electric output signal having a voltage level equivalent to the digital electric input signal at the output terminal 9.

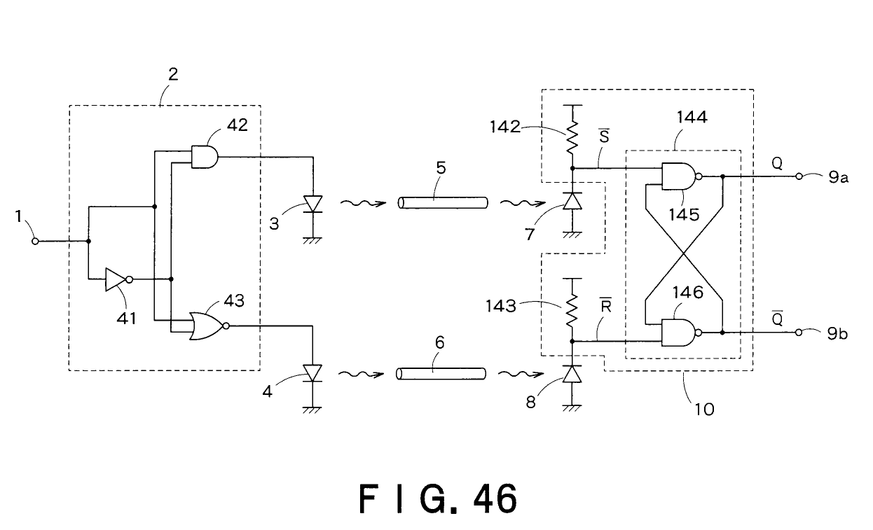

FIG. 46 is a circuit diagram showing a second modification example of the circuit in FIG. 10 and shows an example of the receiving circuit 10 having an internal configuration different from that in FIG. 10 or FIG. 45. The receiving circuit 10 in FIG. 46 includes a resistance element 142 connected between the cathode of the first light-receiving element 7 and a power supply terminal, a resistance element 143 connected between the cathode of the second light-receiving element 8 and a power supply terminal, and an SR flip flop 144 that is set by the voltage of a terminal /S and reset by the voltage of a terminal /R.

An SR flip flop 144 shown here is composed of, for example, two NAND circuits 145 and 146. The connection path /S between the cathode of the first light-receiving element 7 and the resistance element 142, and the connection path /R between the second light-receiving element 8 and the resistance element 143 are charged up to the power supply voltage when there is no optical signal input to the light-receiving elements 7 and 8. When an optical signal is received, the potentials of the connection paths /S and /R decrease by the currents flowing through the light-receiving elements 7 and 8.

The SR flip flop 144 in FIG. 46 is of a negative logic operation type and when the potential of the connection path /S between the cathode of the first light-receiving element 7 and the resistance element 142 falls below a threshold voltage of a MOS transistor in the NAND circuit 145 connected to /S, the SR flip flop 144 is set to a “set” position and the Q terminal becomes “1.” On the other hand, when the potential of the connection path /R between the cathode of the second light-receiving element 8 and the resistance element 143 falls below a threshold voltage of a MOS transistor in the NAND circuit 146 connected to /R, the SR flip flop 144 is set to a “reset” position and the Q terminal becomes “0.”

In this way, the Q terminal of the SR flip flop 144 becomes “1” at the rising edge and “0” at the falling edge of the digital electric input signal.

In the receiving circuit 10 in FIG. 46, the input voltage of the SR flip flop 144 is changed by the received optical signal currents flowing through the resistance elements 142 and 143. In this case, the received optical signal current is restricted by a CR time constant determined by respective capacitances C of the first and second light-receiving elements 7 and 8 and the input terminals of the SR flip flop 144, respective resistances R of the first and second light-receiving elements 7 and 8 and resistance elements 142 and 143, and therefore it is difficult to realize high-speed signal operation. Furthermore, since part of the received optical signal current flows toward the power supply side or grounding side, the power efficiency also deteriorates. Therefore, a circuit configuration that can solve such a problem is also conceivable.

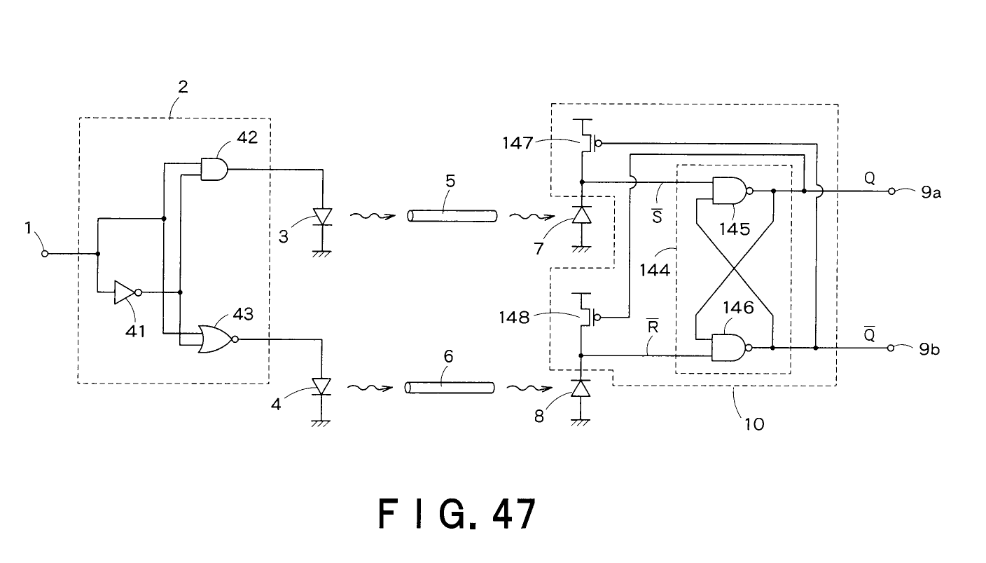

FIG. 47 is a circuit diagram showing a third modification example with the improved receiving circuit 10 in FIG. 46. The receiving circuit 10 in FIG. 47 includes a PMOS transistor 147 connected instead of the resistance element 142 in FIG. 46 and a PMOS transistor 148 connected instead of the resistance element 143 in FIG. 46. The gate of the PMOS transistor 147 is connected to the /Q terminal of the SR flip flop 144 and the gate of the PMOS transistor 148 is connected to the Q terminal of the SR flip flop 144.

In the circuit of FIG. 47, the potential of the connection path between the drain of the PMOS transistor 147 and the cathode of the first light-receiving element 7 is equal to a power supply voltage immediately after the PMOS transistor 147 turns ON and is equal to a grounding voltage immediately after the first light-receiving element 7 receives an optical signal. Likewise, the potential of the connection path between the drain of the PMOS transistor 148 and the cathode of the second light-receiving element 8 is equal to the power supply voltage immediately after the PMOS transistor 148 turns ON and is equal to the grounding voltage immediately after the second light-receiving element 8 receives an optical signal.

Hereinafter, the operation of the circuit in FIG. 47 will be explained. Suppose the SR flip flop 144 is in a condition of (/S,/R)=(1,1) and (Q,/Q)=(0,1). That is, suppose the PMOS transistor 147 is OFF and the PMOS transistor 148 is ON.

In this condition, if the first light-receiving element 7 is assumed to have received an optical signal, since the PMOS transistor 147 is OFF, (/S,/R)=(0,1) and (Q,/Q)=(1,0). This causes the PMOS transistor 147 to turn ON and the PMOS transistor 148 to turn OFF and (/S,/R) becomes (1,1) again, whereas (Q,/Q) remains (1,0).

Next, if the second light-receiving element 8 is assumed to have received an optical signal, since the PMOS transistor 148 is OFF, (/S,/R) becomes (1,0) and (Q,/Q) becomes (0,1). This causes the PMOS transistor 147 to turn OFF and the PMOS transistor 148 to turn ON and (/S,/R) becomes (1,1) again, whereas (Q,/Q) remains (0,1).

Since rising edges and falling edges of the digital electric input signal are alternately repeated, the setting operation and resetting operation of the SR flip flop 144 are also alternately repeated in the receiving circuit 10 of FIG. 47. That is, in the receiving circuit 10 in FIG. 47, a discharging operation at the set input terminal and reset input terminal is performed when the first and second light-receiving elements 7 and 8 receive light, at a state of shutting off the charging operation at the set input terminal and the reset input terminal of the SR flip flop 144 by the PMOS transistors 147 and 148. This allows all received currents generated to be effectively used and makes it possible to realize a complementary optical wiring system with less power consumption.

In the receiving circuit 10 in FIG. 47, NMOS transistors may also be used instead of the PMOS transistors 147 and 148. In this case, it is preferable to connect one of the NMOS transistors and the corresponding first light-receiving element 7 in series, and the other NMOS transistor and the corresponding second light-receiving element 8 in series, in which the NMOS transistors are arranged on the grounding side and the first and second light-receiving element 7 and 8 are on the power supply side, respectively and provide the SR flip flop 144 of positive logic operation. The SR flip flop 144 may also be configured using a logic circuit other than the NAND circuits 145 and 146.

The receiving circuit shown in FIG. 45 to FIG. 47 may also be used as the receiving circuit in the above described various embodiments.

The present invention is not limited to the above described embodiments. The respective blocks, circuits, circuit elements in the circuits and the blocks, and other components explained in the above described respective embodiments are merely examples and can be replaced by alternate products having similar functions as appropriate. For example, an example has been explained above where MOS transistors are used, but field effect transistors other than MOS, bipolar transistors and Bi-CMOS transistors may also be used. Furthermore, various light-emitting elements such as light-emitting diodes and semiconductor lasers can be used as the first and second light-emitting elements 3 and 4. Furthermore, various light-receiving elements such as PIN photodiodes, MSM photodiodes, avalanche photodiodes, and photoconductors can be used as the first and second light-receiving elements 7 and 8. Furthermore, optical fibers or optical waveguides may be used as the first and second optical transmission paths 5 and 6.

Moreover, various types of processing and modifications can be applied without departing from the essence and technical scope of the present invention. Furthermore, the above described various embodiments can be combined appropriately as required.

1. A complementary optical wiring system comprising:
a transmitting circuit configured to combine a delayed signal obtained by delaying a digital electric input signal by a time shorter than a minimum pulse width of the digital electric input signal with the digital electric input signal to generate a first electric pulse signal synchronized with a rising edge of the digital electric input signal and a second electric pulse signal synchronized with a falling edge of the digital electric input signal;
a first light-emitting element configured to convert the first electric pulse signal to a first optical signal;
a second light-emitting element configured to convert the second electric pulse signal to a second optical signal;
a first optical transmission path configured to transmit the first optical signal;
a second optical transmission path configured to transmit the second optical signal;
a first light-receiving element configured to convert the first optical signal transmitted through the first optical transmission path to a third electric pulse signal;
a second light-receiving element configured to convert the second optical signal transmitted through the second optical transmission path to a fourth electric pulse signal; and
a receiving circuit configured to generate a digital electric output signal corresponding to the digital electric input signal in synchronization with the third and fourth electric pulse signals.

2. The system of claim 1,
wherein the delayed signal comprises a first delayed signal obtained by delaying the digital electric input signal by the time shorter than the minimum pulse width of the digital electric input signal and a second delayed signal obtained by delaying a reverse signal of the digital electric input signal by the time shorter than the minimum pulse width of the digital electric input signal,
the transmitting circuit comprises:
a first transmitter configured to combine one of the first and second delayed signal with one of the digital electric input signal and the reverse signal to generate the first electric pulse signal at timing synchronized with the rising edge of the digital electric input signal; and
a second transmitter configured to combine the other of the first and second delayed signal with the other of the digital electric input signal and the reverse signal to generate the second electric pulse signal at timing synchronized with the falling edge of the digital electric input signal.

3. The system of claim 1,
wherein the delayed signal comprises a first delayed signal obtained by delaying the digital electric input signal by the time shorter than the minimum pulse width of the digital electric input signal and a second delayed signal obtained by delaying the digital electric input signal by the time shorter than the minimum pulse width of the digital electric input signal,
the transmitting circuit comprises:
a first transmitter configured to combine the first delayed signal with the digital electric input signal to generate the first electric pulse signal at timing synchronized with the rising edge of the digital electric input signal; and
a second transmitter configured to combine the second delayed signal with the digital electric input signal to generate the second electric pulse signal at timing synchronized with the falling edge of the digital electric input signal.

4. The system of claim 1,
wherein pulse widths of the first and second electric pulse signals are shorter than ½ of the minimum pulse width of the digital electric input signal.

5. The system of claim 1,
wherein the transmitting circuit is capable of controlling the delay time of the delayed signal, and
the transmitting circuit combines the delayed signal with the digital electric input signal to control pulse widths of the first and second electric pulse signals according to the delay time.

6. The system of claim 1,
wherein the transmitting circuit comprises:
a first impedance adjuster configured to variably control at least one of a bias current and a light-emitting current of the first light-emitting element; and
a second impedance adjuster configured to variably control at least one of a bias current and a light-emitting current of the second light-emitting element.

7. The system of claim 6,
wherein the first impedance adjuster comprises a first variable resistance element inserted between the first light-emitting element and a reference voltage terminal, and
the second impedance adjuster comprises a second variable resistance element inserted between the second light-emitting element and the reference voltage terminal.

8. The system of claim 6,
wherein the transmitting circuit comprises:
a first switching element configured to turn ON/OFF in synchronization with the first delayed signal, the digital electric input signal or a signal obtained by combining the first delayed signal with the digital electric input signal; and
a second switching element configured to turn ON/OFF in synchronization with the second delayed signal, the digital electric input signal or a signal obtained by combining the second delayed signal with the digital electric input signal,
the first impedance adjuster comprises:
a first variable resistance element inserted between the first light-emitting element and a reference voltage terminal together with the first switching element, and
the second impedance adjuster comprises:
a second variable resistance element inserted between the second light-emitting element and the reference voltage terminal together with the second switching element.

9. The system of claim 1,
wherein the transmitting circuit comprises:
a short pulse generation circuit configured to generate a short pulse signal comprising a pulse synchronized with the rising edge of the digital electric input signal and a pulse synchronized with the falling edge of the digital electric input signal; and
a separation circuit configured to separate the short pulse signal into the first electric pulse signal synchronized with the rising edge of the digital electric input signal and the second electric pulse signal synchronized with the falling edge of the digital electric input signal.

10. The system of claim 1,
wherein the transmitting circuit comprises a short pulse generation circuit configured to generate a short pulse signal comprising the first electric pulse signal synchronized with the rising edge of the digital electric input signal and the second electric pulse signal synchronized with the falling edge of the digital electric input signal having a reverse polarity of the first electric pulse signal.

11. The system of claim 1, further comprising a feedback signal transmission path connected to the transmitting circuit and the receiving circuit, and configured to transmit a feedback signal from the receiving circuit to the transmitting circuit,
wherein the receiving circuit comprises a feedback signal generation circuit configured to generate the feedback signal indicating whether a peak voltage of the digital electric output signal exceeds a first reference voltage, or whether a voltage-amplitude of the digital electric output signal exceeds a second reference voltage, or whether a voltage proportional to the amount of the jitter of the digital electric output signal exceeds a third reference voltage, and
the transmitting circuit comprises a control circuit configured to control an amount of optical output of the first and second optical signals based on the feedback signal.

12. The system of claim 11,
wherein the control circuit increases the delay time of the delayed signal, when the feedback signal indicates that the peak voltage of the digital electric output signal does not exceed the first reference voltage, or indicates that the voltage-amplitude of the digital electric output signal does not exceed the second reference voltage, or the voltage proportional to the amount of the jitter of the digital electric output signal exceeds the third reference voltage, and
decreases the delay time to delay the digital electric input signal, when the feedback signal indicates that the peak voltage of the digital electric output signal exceeds the first reference voltage, or indicates that the voltage-amplitude of the digital electric output signal exceeds the second reference voltage, or the voltage proportional to the amount of the jitter of the digital electric output signal does not exceed the third reference voltage to control the amount of optical outputs of the first and second optical signals.

13. The system of claim 1,
wherein the transmitting circuit comprises:
a logic inversion circuit configured to generate the delayed signal; and
a plurality of logic operation circuits configured to generate the first electric pulse signal and the second electric pulse signal based on the digital electric input signal and the delayed signal.

14. The system of claim 1,
wherein the transmitting circuit comprises:
a logic inversion circuit configured to generate the delayed signal;
a plurality of logic operation circuits configured to generate a first intermediate pulse signal corresponding to the first electric pulse signal and a second intermediate pulse signal corresponding to the second electric pulse signal based on the digital electric input signal and the delayed signal;
a first switching element configured to turn ON/OFF based on logic of the first intermediate pulse signal to generate the first electric pulse signal; and
a second switching element configured to turn ON/OFF based on logic of the second intermediate pulse signal to generate the second electric pulse signal.

15. A complementary optical wiring system comprising:
a transmitting circuit comprising a first frequency division circuit configured to generate a first frequency-divided signal whose logic is inverted in synchronization with a rising edge of a digital electric input signal, a second frequency division circuit configured to generate a second frequency-divided signal whose logic is inverted in synchronization with a falling edge of the digital electric input signal, a first electric pulse signal generation circuit configured to generate a first electric pulse signal at timing synchronized with a logical transition of the first frequency-divided signal and a second electric pulse signal generation circuit configured to generate a second electric pulse signal at timing synchronized with a logical transition of the second frequency-divided signal;
a first light-emitting element configured to generate a first optical signal synchronized with the first electric pulse signal;
a second light-emitting element configured to generate a second optical signal synchronized with the second electric pulse signal;
a first optical transmission path configured to transmit the first optical signal;
a second optical transmission path configured to transmit the second optical signal;
a first light-receiving element configured to convert the first optical signal transmitted through the first optical transmission path to a third electric pulse signal;
a second light-receiving element configured to convert the second optical signal transmitted through the second optical transmission path to a fourth electric pulse signal; and
a receiving circuit configured to generate a digital electric output signal corresponding to the digital electric input signal in synchronization with the third and fourth electric pulse signals.

16. The system of claim 15,
wherein pulse widths of the first and second electric pulse signals are shorter than ½ of a minimum pulse width of the digital electric input signal.

17. The system of claim 15, further comprising a feedback signal transmission path connected to the transmitting circuit and the receiving circuit, and configured to transmit a feedback signal from the receiving circuit to the transmitting circuit,
wherein the receiving circuit comprises a feedback signal generation circuit configured to generate the feedback signal indicating whether a peak voltage of the digital electric output signal exceeds a first reference voltage, or whether a voltage-amplitude of the digital electric output signal exceeds a second reference voltage, or whether a voltage proportional to the amount of the jitter of the digital electric output signal exceeds a third reference voltage, and
the transmitting circuit comprises a control circuit configured to control an amount of optical output of the first and second optical signals based on the feedback signal.

18. The system of claim 15,
wherein the transmitting circuit comprises:
a first variable capacitor connected between an input terminal of the first electric pulse signal generation circuit and a grounding terminal, the first variable capacitor having adjustable capacitance; and
a second variable capacitor connected between an input terminal of the second electric pulse signal generation circuit and a grounding terminal, the second variable capacitor having adjustable capacitance.

19. The system of claim 18, further comprising a feedback signal transmission path connected to the transmitting circuit and the receiving circuit, and configured to transmit a feedback signal from the receiving circuit to the transmitting circuit,
wherein the receiving circuit comprises a feedback signal generation circuit configured to generate the feedback signal indicating whether a peak voltage of the digital electric output signal exceeds a first reference voltage, or whether a voltage-amplitude of the digital electric output signal exceeds a second reference voltage, or whether a voltage proportional to the amount of the jitter of the digital electric output signal exceeds a third reference voltage, and
the transmitting circuit comprises a control circuit configured to control capacitances of the first and second variable capacitors based on the feedback signal, to control an amount of optical output of the first and second optical signals.

20. A complementary optical wiring system comprising:
a transmitting circuit configured to generate first and second electric pulse signals synchronized with a rising edge and a falling edge of a digital electric input signal;
a first light-emitting element configured to generate a first optical signal synchronized with the first electric pulse signal;
a second light-emitting element configured to generate a second optical signal synchronized with the second electric pulse signal;
a first optical transmission path configured to transmit the first optical signal;
a second optical transmission path configured to transmit the second optical signal;
a first light-receiving element configured to convert the first optical signal transmitted through the first optical transmission path to a third electric pulse signal;
a second light-receiving element configured to convert the second optical signal transmitted through the second optical transmission path to a fourth electric pulse signal;
a receiving circuit comprising a digital received signal generation circuit configured to generate a digital electric output signal corresponding to the digital electric input signal in synchronization with the third and fourth electric pulse signals and a feedback signal generation circuit configured to generate a feedback signal indicating whether a peak voltage of the digital electric output signal exceeds a first reference voltage or whether a voltage-amplitude of the digital electric output signal exceeds a second reference voltage, or whether a voltage proportional to the amount of the jitter of the digital electric output signal exceeds a third reference voltage; and
a feedback signal transmission path configured to be connected to the transmitting circuit and the receiving circuit and configured to transmit the feedback signal from the receiving circuit to the transmitting circuit,
wherein the transmitting circuit comprises a control circuit configured to control an amount of optical output of the first and second optical signals based on the feedback signal.
